(19) United States
(12) Patent Application Publication
(10) Pub. No.: US 2026/0291279 A1
(43) Pub. Date: Sep. 24, 2026

(54) METHODS AND SYSTEMS FOR DISTRIBUTED UTILITY INTELLIGENCE ARCHITECTURE

(71) Applicant: Delta Energy & Communications, Inc., Murrieta, CA (US)

(72) Inventors: Scott FOSTER, Murrieta, CA (US); Everardo CAMACHO, Costa Mesa, CA (US)

(21) Appl. No.: 19/647,429

(22) Filed: Apr. 14, 2026

Related U.S. Application Data
(63) Continuation of application No. PCT/US2026/020425, filed on Mar. 23, 2026.
(60) Provisional application No. 63/776,779, filed on Mar. 24, 2025.

(51) Int. Cl. H02J 13/12; G06N 3/04; G06N 3/098; G06N 5/04; G06Q 50/06; H02J 3/00; H02J 3/001; H02J 3/0012; H02J 3/0014; H02J 3/38; H02J 13/13; H02J 13/16; H02J 13/333; H02J 101/22; H02J 103/35; H02J 105/42; H02J 107/20

(52) U.S. Cl. CPC H02J 13/12; G06N 3/04; G06N 3/098; G06N 5/04; H02J 3/0012; H02J 3/00125; H02J 3/0014; H02J 3/003; H02J 3/381; H02J 13/1331; H02J 13/16; H02J 13/333; G06Q 50/06; H02J 2101/22; H02J 2103/35; H02J 2105/42; H02J 2107/20

(57) ABSTRACT

The distributed utility intelligence architecture comprises at least four hierarchical tiers of AI components configured to manage a utility network, comprising a first tier of one or more first AI components, a second tier of one or more second AI components, a third tier of one or more third AI components, and a fourth tier of one or more fourth AI components. The first tier is configured to monitor electrical data of the utility network. The second tier is configured to monitor electrical data of a transformer within the utility network. The third tier is configured to monitor electrical data of a service point corresponding to the transformer. The fourth tier is configured to monitor electrical data of an appliance at the service point.

### CROSS-REFERENCE

This application is a continuation of International Application No. PCT/US2026/020425, filed Mar. 23, 2026, which claims the benefit of U.S. Provisional Application No. 63/776,779, filed Mar. 24, 2025, each of which is incorporated herein by reference in its entirety.

### BACKGROUND

Modern utility infrastructure management faces unprecedented challenges, including integration of distributed energy resources (DERs) (e.g., residential solar, wind generation, or battery storage); increasing frequency of extreme weather events threatening infrastructure reliability; growing consumer expectations for service quality and transparent energy insights; detection and prevention of non-technical losses (e.g., energy theft); management of complex mesh networks connecting millions of intelligent devices; and real-time optimization across multiple operational objectives.

Conventional utility management systems rely on centralized architectures that struggle with the volume and velocity of data generated by modern smart grid infrastructure. These systems suffer from communication bottlenecks, lack real-time responsiveness, create single points of failure, and fail to leverage distributed computational resources embedded throughout the network.

### SUMMARY

In some aspects, the present disclosure provides a distributed utility intelligence architecture. In some embodiments, the distributed utility intelligence architecture comprises at least four hierarchical tiers of one or more artificial intelligence (AI) components configured to manage a utility network. In some embodiments, the at least four hierarchical tiers of one or more AI components comprise a first tier of one or more first AI components, a second tier of one or more second AI components, a third tier of one or more third AI components, and a fourth tier of one or more fourth AI components. In some embodiments, the first tier is configured to direct activity of at least the second tier, the third tier, and the fourth tier. In some embodiments, the first tier is configured to monitor electrical data of the utility network. In some embodiments, the second tier is configured to direct activity of at least the third tier and fourth tier. In some embodiments, the second tier is configured to monitor electrical data of a transformer within the utility network. In some embodiments, the third tier is configured to direct activity of at least the fourth tier. In some embodiments, the third tier is configured to monitor electrical data of a service point corresponding to the transformer. In some embodiments, the fourth tier is configured to monitor electrical data of an appliance at the service point. In some embodiments, one or more of the one or more first AI components, the one or more second AI components, the one or more third AI components, or the one or more fourth AI components comprise a processing unit and a sensory interface unit. In some embodiments, the processing unit comprises an AI model that is configured to perform a utility operation function. In some embodiments, the sensory interface unit is configured to provide utility sensor data to the processing unit. In some embodiments, the processing unit is configured to process the utility sensor data with the AI model to perform the utility operation function. In some embodiments, the sensory interface unit is configured to use one or more of: an electrical parameter, a network parameter, an environmental parameter, or a state parameter. In some embodiments, the sensory interface unit comprises a sensor interface layer, a signal processing layer, an event detection layer, a context enrichment layer, and a communication layer. In some embodiments, the sensor interface layer comprises a hardware-specific driver for data acquisition. In some embodiments, the signal processing layer comprises a digital signal processing algorithm configured to perform data transformation. In some embodiments, the event detection layer is configured to perform pattern matching or threshold monitoring to detect network events. In some embodiments, the AI model comprises a neural network model. In some embodiments, the distributed utility intelligence architecture is configured to perform a parameter compression technique to reduce a size of the neural network model. In some embodiments, the distributed utility intelligence architecture is configured to refine the AI model based on performance. In some embodiments, the distributed utility intelligence architecture is configured to refine, using federated learning, one or more of: the one or more first AI components, the one or more second AI components, the one or more third AI components, or the one or more fourth AI components. In some embodiments, the distributed utility intelligence architecture is configured to perform elastic weight consolidation. In some embodiments, the distributed utility intelligence architecture is configured to perform knowledge distillation regularization. In some embodiments, the at least four hierarchical tiers are configured such that information flows upward from the fourth tier to the third tier, from the third tier to the second tier, or from the second tier to the first tier. In some embodiments, the at least four hierarchical tiers are configured such that information flows downward from the first tier to the second tier, from the second tier to the third tier, or from the third tier to the fourth tier. In some embodiments, the at least four hierarchical tiers are configured such that information flows horizontally between one AI component and another AI component in a same tier. In some embodiments, the at least four hierarchical tiers are configured such that information flows across tiers that are not directly connected. In some embodiments, the distributed utility intelligence architecture comprises one or more of: a grid stability model, an asset health model, a consumption pattern model, a network resilience model, a resource optimization model, or a customer experience model. In some embodiments, the distributed utility intelligence architecture further comprises a generative AI agent. In some embodiments, the generative AI agent is configured to autonomously generate a software tool to address an operational gap identified during continuous grid monitoring. In some embodiments, a processing unit in the first tier comprises a neural network with at least 1,000,000 parameters. In some embodiments, the one or more first AI components in the first tier are deployed on an online grid management and monitoring platform. In some embodiments, the one or more first AI components in the first tier are configured to receive telemetry data from the one or more second AI components in the second tier. In some embodiments, the telemetry data from the one or more second AI components in the second tier comprises data about one or more of: transformer-level power flow, outage reports, or weather data. In some embodiments, the one or more first AI components in the first tier are configured to perform system-wide load pattern analysis of the utility network based on the telemetry data from the one or more second AI components in the second tier. In some embodiments, if the system-wide load pattern analysis forecasts an impending demand peak, the one or more first AI components in the first tier are configured to instruct the one or more second AI components in the second tier to implement a directive to handle the impending demand peak. In some embodiments, the directive is a load-shedding plan or demand-response initiative. In some embodiments, the one or more first AI components in the first tier are configured to correlate the data about transformer-level power flow with historical consumption data or with the weather data. In some embodiments, the one or more first AI components in the first tier are configured to predict demand spikes on the utility network and adjust system-wide distribution strategies on the network in response to the demand spikes. In some embodiments, the one or more first AI components in the first tier are configured to perform demand forecasting for the utility network. In some embodiments, the one or more first AI components in the first tier are configured to predict a load distribution on the utility network between about 24 hours and about 72 hours in advance of electricity use. In some embodiments, the one or more first AI components in the first tier are configured to detect a distribution-level anomaly affecting two or more circuits of the utility network. In some embodiments, the distribution-level anomaly comprises simultaneous voltage fluctuations across the two or more circuits that are outside of typical usage patterns of the utility network. In some embodiments, if the distribution-level anomaly is detected, the one or more first AI components in the first tier are configured to one or more of: alert a utility operator, dispatch an automated alert, isolate an affected segment, or initiate a further diagnostic process. In some embodiments, the one or more first AI components in the first tier are configured to perform long-range load forecasting for resource planning. In some embodiments, a processing unit in the second tier comprises a neural network with between 1,000 parameters and 100,000 parameters. In some embodiments, the one or more second AI components in the second tier are deployed on one or more distribution transformer smart hubs corresponding to the transformer of the utility network. In some embodiments, the one or more second AI components in the second tier are configured to receive telemetry data from the one or more third AI components in the third tier. In some embodiments, the telemetry data from the one or more third AI components in the third tier comprises one or more of: data of real-time voltage levels, data of current flow, data of harmonics, data of transformer temperature, data of vibration, or data of load distribution. In some embodiments, the one or more second AI components in the second tier are configured to perform local electrical characteristic analysis using the data of load distribution and the data of transformer temperature. In some embodiments, if the one or more second AI components in the second tier detect a temperature anomaly or a transformer overloading, the one or more second AI components in the second tier are configured to implement a control directive on the transformer of the utility network. In some embodiments, the control directive instructs the distributed utility intelligence architecture to one or more of: dynamically adjust tap changer settings, redistribute local load, or adjust a local circuit parameter. In some embodiments, the local electrical characteristic analysis performed using the data of load distribution and the data of transformer temperature is used to predict potential transformer overheating of the transformer of the utility network. In some embodiments, the one or more second AI components in the second tier are configured to detect a transformer-level anomaly of the transformer of the utility network. In some embodiments, the transformer-level anomaly is a rapid increase in transformer vibration or a temperature spike without a corresponding load change of the transformer of the utility network. In some embodiments, if the transformer-level anomaly is detected, the one or more second AI components in the second tier are configured to one or more of: generate a maintenance work order, initiate local load redistribution to mitigate risk, or communicate with the one or more first AI components in the first tier. In some embodiments, the one or more second AI components in the second tier are configured to perform medium-range equipment health prediction for maintenance planning on the transformer of the utility network. In some embodiments, a processing unit in the third tier comprises a neural network with between 100 parameters and 999 parameters. In some embodiments, the one or more third AI components in the third tier are deployed on one or more smart meters at the service point. In some embodiments, the one or more third AI components in the third tier are configured to collect customer usage data at the service point at regular intervals. In some embodiments, the customer usage data comprises one or more of: kilowatt-hour (kWh) consumption, a voltage dip or spike, an outage, or a demand profile. In some embodiments, the regular intervals are 5-minute increments, 15-minute increments, or 30-minute increments. In some embodiments, the one or more third AI components in the third tier are configured to use the customer usage data to detect abnormal electricity usage at the service point as compared to historical usage patterns. In some embodiments, if the abnormal electricity usage at the service point is detected, the one or more third AI components in the third tier are configured to one or more of: notify the one or more second AI components in the second tier, flag data from the service point for increased monitoring, or log event details for utility records. In some embodiments, the one or more third AI components in the third tier are configured to perform short-range consumption prediction for load balancing. In some embodiments, a processing unit in the fourth tier comprises an inference model with fewer than 100 parameters. In some embodiments, the one or more fourth AI components in the fourth tier are deployed on one or more in-home or business wireless routers. In some embodiments, the one or more fourth AI components in the fourth tier are configured to detect degraded Wi-Fi telemetry of the appliance. In some embodiments, the distributed utility intelligence architecture is further configured to optimize usage of the appliance or the one or more in-home or business wireless routers based on telemetry from the appliance or the one or more in-home or business wireless routers. In some embodiments, the one or more fourth AI components in the fourth tier are configured to detect a usage anomaly of the appliance. In some embodiments, if the usage anomaly of the appliance is detected, the one or more fourth AI components in the fourth tier are configured to one or more of: issue a user-level alert, issue an automated configuration adjustment to stabilize connectivity of the appliance, or provide personalized guidance to the customer through a customer engagement platform. In some embodiments, the one or more fourth AI components in the fourth tier are configured to perform immediate range connectivity prediction for quality of service. In some embodiments, the distributed utility intelligence architecture further comprises a fifth tier of one or more fifth AI components, wherein the fifth tier is configured to monitor electrical data of one or more of: an electrical substation, a power plant, or a transmission line.

In some aspects, the present disclosure provides a system for distributed utility intelligence. In some embodiments, the system comprises a first AI component configured to monitor electrical data of a utility network. In some embodiments, the system comprises a second AI component configured to monitor electrical data of a transformer within the utility network. In some embodiments, the system comprises a third AI component configured to monitor electrical data of a service point corresponding to the transformer. In some embodiments, the system comprises a fourth AI component configured to monitor electrical data of an appliance located at the service point. In some embodiments, the first AI component is configured to direct activity of the second, third, and fourth AI components. In some embodiments, the second AI component is configured to direct activity of the third and fourth AI components. In some embodiments, the third AI component is configured to direct activity of the fourth AI component.

In some aspects, the present disclosure provides a method for managing a utility network. In some embodiments, the method comprises: (a) monitoring electrical data of a utility network using one or more first AI components; (b) monitoring electrical data of a transformer within the utility network using one or more second AI components; (c) monitoring electrical data of a service point corresponding to the transformer using one or more third AI components; and (d) monitoring electrical data of an appliance located at the service point using one or more fourth AI components. In some embodiments, the one or more first AI components are included in a first hierarchical tier that directs activity of the one or more second AI components, the one or more third AI components, and the one or more fourth AI components. In some embodiments, the one or more second AI components are included in a second hierarchical tier that directs activity of the one or more third AI components and the one or more fourth AI components. In some embodiments, the one or more third AI components are included in a third hierarchical tier that directs activity of the one or more fourth AI components. In some embodiments, the one or more fourth AI components are included in a fourth hierarchical tier. In some embodiments, one or more of the one or more first AI components, the one or more second AI components, the one or more third AI components, or the one or more fourth AI components comprise a processing unit and a sensory interface unit. In some embodiments, the processing unit comprises an AI model that performs a utility operation function. In some embodiments, the sensory interface unit provides utility sensor data to the processing unit. In some embodiments, the processing unit processes the utility sensor data with the AI model to perform the utility operation function. In some embodiments, the sensory interface unit uses one or more of: an electrical parameter, a network parameter, an environmental parameter, or a state parameter. In some embodiments, the sensory interface unit comprises a sensor interface layer, a signal processing layer, an event detection layer, a context enrichment layer, and a communication layer. In some embodiments, the sensor interface layer comprises a hardware-specific driver for data acquisition. In some embodiments, the signal processing layer comprises a digital signal processing algorithm configured to perform data transformation. In some embodiments, the event detection layer performs pattern matching or threshold monitoring to detect network events. In some embodiments, the AI model comprises a neural network model. In some embodiments, the method further comprises performing a parameter compression technique to reduce a size of the neural network model. In some embodiments, the method further comprises refining the AI model based on performance. In some embodiments, the method further comprises refining, using federated learning, one or more of: the one or more first AI components, the one or more second AI components, the one or more third AI components, or the one or more fourth AI components. In some embodiments, the method further comprises performing elastic weight consolidation. In some embodiments, the method further comprises performing knowledge distillation regularization. In some embodiments, information flows upward from the fourth tier to the third tier, from the third tier to the second tier, or from the second tier to the first tier. In some embodiments, information flows downward from the first tier to the second tier, from the second tier to the third tier, or from the third tier to the fourth tier. In some embodiments, information flows horizontally between one AI component and another AI component in a same tier. In some embodiments, information flows across tiers that are not directly connected. In some embodiments, the method further comprises the use of one or more of: a grid stability model, an asset health model, a consumption pattern model, a network resilience model, a resource optimization model, or a customer experience model. In some embodiments, the method further comprises the use of a generative AI agent. In some embodiments, the generative AI agent autonomously generates a software tool to address an operational gap identified during continuous grid monitoring. In some embodiments, a processing unit in the first tier comprises a neural network with at least 1,000,000 parameters. In some embodiments, the one or more first AI components in the first tier are deployed on an online grid management and monitoring platform. In some embodiments, the one or more first AI components in the first tier are configured to receive telemetry data from the one or more second AI components in the second tier. In some embodiments, the telemetry data from the one or more second AI components in the second tier comprises data about one or more of: transformer-level power flow, outage reports, or weather data. In some embodiments, the one or more first AI components in the first tier perform system-wide load pattern analysis of the utility network based on the telemetry data from the one or more second AI components in the second tier. In some embodiments, if the system-wide load pattern analysis forecasts an impending demand peak, the one or more first AI components in the first tier instruct the one or more second AI components in the second tier to implement a directive to handle the impending demand peak. In some embodiments, the directive is a load-shedding plan or demand-response initiative. In some embodiments, the one or more first AI components in the first tier correlate the data about transformer-level power flow with historical consumption data or with the weather data. In some embodiments, the one or more first AI components in the first tier predict demand spikes on the utility network and adjust system-wide distribution strategies on the network in response to the demand spikes. In some embodiments, the one or more first AI components in the first tier perform demand forecasting for the utility network. In some embodiments, the one or more first AI components in the first tier predict a load distribution on the utility network between about 24 hours and about 72 hours in advance of electricity use. In some embodiments, the one or more first AI components in the first tier detect a distribution-level anomaly affecting two or more circuits of the utility network. In some embodiments, the distribution-level anomaly comprises simultaneous voltage fluctuations across the two or more circuits that are outside of typical usage patterns of the utility network. In some embodiments, if the distribution-level anomaly is detected, the one or more first AI components in the first tier do one or more of: alert a utility operator, dispatch an automated alert, isolate an affected segment, or initiate a further diagnostic process. In some embodiments, the one or more first AI components in the first tier perform long-range load forecasting for resource planning. In some embodiments, a processing unit in the second tier comprises a neural network with between 1,000 parameters and 100,000 parameters. In some embodiments, the one or more second AI components in the second tier are deployed on one or more distribution transformer smart hubs corresponding to the transformer of the utility network. In some embodiments, the one or more second AI components in the second tier are configured to receive telemetry data from the one or more third AI components in the third tier. In some embodiments, the telemetry data from the one or more third AI components in the third tier comprises one or more of: data of real-time voltage levels, data of current flow, data of harmonics, data of transformer temperature, data of vibration, or data of load distribution. In some embodiments, the one or more second AI components in the second tier perform local electrical characteristic analysis using the data of load distribution and the data of transformer temperature. In some embodiments, if the one or more second AI components in the second tier detect a temperature anomaly or a transformer overloading, the one or more second AI components in the second tier implement a control directive on the transformer of the utility network. In some embodiments, the method further comprises using the control directive to do one or more of: dynamically adjust tap changer settings, redistribute local load, or adjust a local circuit parameter. In some embodiments, the local electrical characteristic analysis performed using the data of load distribution and the data of transformer temperature is used to predict potential transformer overheating of the transformer of the utility network. In some embodiments, the one or more second AI components in the second tier detect a transformer-level anomaly of the transformer of the utility network. In some embodiments, the transformer-level anomaly is a rapid increase in transformer vibration or a temperature spike without a corresponding load change of the transformer of the utility network. In some embodiments, if the transformer-level anomaly is detected, the one or more second AI components in the second tier do one or more of: generate a maintenance work order, initiate local load redistribution to mitigate risk, or communicate with the one or more first AI components in the first tier. In some embodiments, the one or more second AI components in the second tier perform medium-range equipment health prediction for maintenance planning on the transformer of the utility network. In some embodiments, a processing unit in the third tier comprises a neural network with between 100 parameters and 999 parameters. In some embodiments, the one or more third AI components in the third tier are deployed on one or more smart meters at the service point. In some embodiments, the one or more third AI components in the third tier collect customer usage data at the service point at regular intervals. In some embodiments, the customer usage data comprises one or more of: kilowatt-hour (kWh) consumption, a voltage dip or spike, an outage, or a demand profile. In some embodiments, the regular intervals are 5-minute increments, 15-minute increments, or 30-minute increments. In some embodiments, the one or more third AI components in the third tier use the customer usage data to detect abnormal electricity usage at the service point as compared to historical usage patterns. In some embodiments, if the abnormal electricity usage at the service point is detected, the one or more third AI components in the third tier do one or more of: notify the one or more second AI components in the second tier, flag data from the service point for increased monitoring, or log event details for utility records. In some embodiments, the one or more third AI components in the third tier perform short-range consumption prediction for load balancing. In some embodiments, a processing unit in the fourth tier comprises an inference model with fewer than 100 parameters. In some embodiments, the one or more fourth AI components in the fourth tier are deployed on one or more in-home or business wireless routers. In some embodiments, the one or more fourth AI components in the fourth tier detect degraded Wi-Fi telemetry of the appliance, if present. In some embodiments, the method further comprises optimizing usage of the appliance or the one or more in-home or business wireless routers based on telemetry from the appliance or the one or more in-home or business wireless routers. In some embodiments, the one or more fourth AI components in the fourth tier detect a usage anomaly of the appliance, if present. In some embodiments, if the usage anomaly of the appliance is detected, the one or more fourth AI components in the fourth tier do one or more of: issue a user-level alert, issue an automated configuration adjustment to stabilize connectivity of the appliance, or provide personalized guidance to the customer through a customer engagement platform. In some embodiments, the one or more fourth AI components in the fourth tier perform immediate range connectivity prediction for quality of service. In some embodiments, the method further comprises further monitoring electrical data of an electrical substation, a power plant, or a transmission line, using a fifth tier of one or more fifth AI components.

In some aspects, the present disclosure provides an AI component for managing a utility network. In some embodiments, the AI component comprises a processing unit configured to execute an AI model; and a sensory interface unit configured to provide utility sensor data to the processing unit. In some embodiments, the processing unit is configured to process the utility sensor data with the AI model to produce instructions for utility operations.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an example of a schematic of the relationships between each of the four tiers and their corresponding artificial intelligence perception units (APUs) and artificial intelligence cognition units (ACUs);

FIG. 2 shows an example of a method flowchart illustrating operations performed to implement distributed intelligence in a utility network using the ACUs and APUs described;

FIG. 3 shows an example of a system architecture diagram depicting the distributed utility intelligence architecture comprising hierarchical AI processing units deployed across multiple tiers of utility network topology; and

FIG. 4 shows an example of a computer system that is programmed or otherwise configured to implement methods provided herein.

### DETAILED DESCRIPTION

In some aspects, the present disclosure provides a distributed utility intelligence architecture. In some embodiments, the distributed utility intelligence architecture comprises at least four hierarchical tiers of one or more artificial intelligence (AI) components configured to manage a utility network. In some embodiments, the at least four hierarchical tiers of one or more AI components are included in a first tier of one or more first AI components, a second tier of one or more second AI components, a third tier of one or more third AI components, and a fourth tier of one or more fourth AI components. In some embodiments, the first tier is configured to direct activity of at least the second tier, the third tier, and the fourth tier. In some embodiments, the first tier is configured to monitor electrical data of the utility network. In some embodiments, the second tier is configured to direct activity of at least the third tier and fourth tier. In some embodiments, the second tier is configured to monitor electrical data of a transformer within the utility network. In some embodiments, the third tier is configured to direct activity of at least the fourth tier. In some embodiments, the third tier is configured to monitor electrical data of a service point corresponding to the transformer. In some embodiments, the fourth tier is configured to monitor electrical data of an appliance at the service point. In some embodiments, one or more of the one or more first AI components, the one or more second AI components, the one or more third AI components, or the one or more fourth AI components comprise a processing unit and a sensory interface unit. In some embodiments, the processing unit comprises an AI model that is configured to perform a utility operation function. In some embodiments, the sensory interface unit is configured to provide utility sensor data to the processing unit. In some embodiments, the processing unit is configured to process the utility sensor data with the AI model to perform the utility operation function. In some embodiments, the sensory interface unit is configured to use one or more of: an electrical parameter, a network parameter, an environmental parameter, or a state parameter. In some embodiments, the sensory interface unit comprises a sensor interface layer, a signal processing layer, an event detection layer, a context enrichment layer, and a communication layer. In some embodiments, the sensor interface layer comprises a hardware-specific driver for data acquisition. In some embodiments, the signal processing layer comprises a digital signal processing algorithm configured to perform data transformation. In some embodiments, the event detection layer is configured to perform pattern matching or threshold monitoring to detect network events. In some embodiments, the AI model comprises a neural network model. In some embodiments, the distributed utility intelligence architecture is configured to perform a parameter compression technique to reduce a size of the neural network model. In some embodiments, the distributed utility intelligence architecture is configured to refine the AI model based on performance. In some embodiments, the distributed utility intelligence architecture is configured to refine, using federated learning, one or more of: the one or more first AI components, the one or more second AI components, the one or more third AI components, or the one or more fourth AI components. In some embodiments, the distributed utility intelligence architecture is configured to perform elastic weight consolidation. In some embodiments, the distributed utility intelligence architecture is configured to perform knowledge distillation regularization. In some embodiments, the at least four hierarchical tiers are configured such that information flows upward from the fourth tier to the third tier, from the third tier to the second tier, or from the second tier to the first tier. In some embodiments, the at least four hierarchical tiers are configured such that information flows downward from the first tier to the second tier, from the second tier to the third tier, or from the third tier to the fourth tier. In some embodiments, the at least four hierarchical tiers are configured such that information flows horizontally between one AI component and another AI component in a same tier. In some embodiments, the at least four hierarchical tiers are configured such that information flows across tiers that are not directly connected. In some embodiments, the distributed utility intelligence architecture comprises one or more of: a grid stability model, an asset health model, a consumption pattern model, a network resilience model, a resource optimization model, or a customer experience model. In some embodiments, the distributed utility intelligence architecture further comprises a generative AI agent. In some embodiments, the generative AI agent is configured to autonomously generate a software tool to address an operational gap identified during continuous grid monitoring. In some embodiments, a processing unit in the first tier comprises a neural network with at least 1,000,000 parameters. In some embodiments, the one or more first AI components in the first tier are deployed on an online grid management and monitoring platform. In some embodiments, the one or more first AI components in the first tier are configured to receive telemetry data from the one or more second AI components in the second tier. In some embodiments, the telemetry data from the one or more second AI components in the second tier comprises data about one or more of: transformer-level power flow, outage reports, or weather data. In some embodiments, the one or more first AI components in the first tier are configured to perform system-wide load pattern analysis of the utility network based on the telemetry data from the one or more second AI components in the second tier. In some embodiments, if the system-wide load pattern analysis forecasts an impending demand peak, the one or more first AI components in the first tier are configured to instruct the one or more second AI components in the second tier to implement a directive to handle the impending demand peak. In some embodiments, the directive is a load-shedding plan or demand-response initiative. In some embodiments, the one or more first AI components in the first tier are configured to correlate the data about transformer-level power flow with historical consumption data or with the weather data. In some embodiments, the one or more first AI components in the first tier are configured to predict demand spikes on the utility network and adjust system-wide distribution strategies on the network in response to the demand spikes. In some embodiments, the one or more first AI components in the first tier are configured to perform demand forecasting for the utility network. In some embodiments, the one or more first AI components in the first tier are configured to predict a load distribution on the utility network between about 24 hours and about 72 hours in advance of electricity use. In some embodiments, the one or more first AI components in the first tier are configured to detect a distribution-level anomaly affecting two or more circuits of the utility network. In some embodiments, the distribution-level anomaly comprises simultaneous voltage fluctuations across the two or more circuits that are outside of typical usage patterns of the utility network. In some embodiments, if the distribution-level anomaly is detected, the one or more first AI components in the first tier are configured to one or more of: alert a utility operator, dispatch an automated alert, isolate an affected segment, or initiate a further diagnostic process. In some embodiments, the one or more first AI components in the first tier are configured to perform long-range load forecasting for resource planning. In some embodiments, a processing unit in the second tier comprises a neural network with between 1,000 parameters and 100,000 parameters. In some embodiments, the one or more second AI components in the second tier are deployed on one or more distribution transformer smart hubs corresponding to the transformer of the utility network. In some embodiments, the one or more second AI components in the second tier are configured to receive telemetry data from the one or more third AI components in the third tier. In some embodiments, the telemetry data from the one or more third AI components in the third tier comprises one or more of: data of real-time voltage levels, data of current flow, data of harmonics, data of transformer temperature, data of vibration, or data of load distribution. In some embodiments, the one or more second AI components in the second tier are configured to perform local electrical characteristic analysis using the data of load distribution and the data of transformer temperature. In some embodiments, if the one or more second AI components in the second tier detect a temperature anomaly or a transformer overloading, the one or more second AI components in the second tier are configured to implement a control directive on the transformer of the utility network. In some embodiments, the control directive instructs the distributed utility intelligence architecture to one or more of: dynamically adjust tap changer settings, redistribute local load, or adjust a local circuit parameter. In some embodiments, the local electrical characteristic analysis performed using the data of load distribution and the data of transformer temperature is used to predict potential transformer overheating of the transformer of the utility network. In some embodiments, the one or more second AI components in the second tier are configured to detect a transformer-level anomaly of the transformer of the utility network. In some embodiments, the transformer-level anomaly is a rapid increase in transformer vibration or a temperature spike without a corresponding load change of the transformer of the utility network. In some embodiments, if the transformer-level anomaly is detected, the one or more second AI components in the second tier are configured to one or more of: generate a maintenance work order, initiate local load redistribution to mitigate risk, or communicate with the one or more first AI components in the first tier. In some embodiments, the one or more second AI components in the second tier are configured to perform medium-range equipment health prediction for maintenance planning on the transformer of the utility network. In some embodiments, a processing unit in the third tier comprises a neural network with between 100 parameters and 999 parameters. In some embodiments, the one or more third AI components in the third tier are deployed on one or more smart meters at the service point. In some embodiments, the one or more third AI components in the third tier are configured to collect customer usage data at the service point at regular intervals. In some embodiments, the customer usage data comprises one or more of: kilowatt-hour (kWh) consumption, a voltage dip or spike, an outage, or a demand profile. In some embodiments, the regular intervals are 5-minute increments, 15-minute increments, or 30-minute increments. In some embodiments, the one or more third AI components in the third tier are configured to use the customer usage data to detect abnormal electricity usage at the service point as compared to historical usage patterns. In some embodiments, if the abnormal electricity usage at the service point is detected, the one or more third AI components in the third tier are configured to one or more of: notify the one or more second AI components in the second tier, flag data from the service point for increased monitoring, or log event details for utility records. In some embodiments, the one or more third AI components in the third tier are configured to perform short-range consumption prediction for load balancing. In some embodiments, a processing unit in the fourth tier comprises an inference model with fewer than 100 parameters. In some embodiments, the one or more fourth AI components in the fourth tier are deployed on one or more in-home or business wireless routers. In some embodiments, the one or more fourth AI components in the fourth tier are configured to detect degraded Wi-Fi telemetry of the appliance. In some embodiments, the distributed utility intelligence architecture is further configured to optimize usage of the appliance or the one or more in-home or business wireless routers based on telemetry from the appliance or the one or more in-home or business wireless routers. In some embodiments, the one or more fourth AI components in the fourth tier are configured to detect a usage anomaly of the appliance. In some embodiments, if the usage anomaly of the appliance is detected, the one or more fourth AI components in the fourth tier are configured to one or more of: issue a user-level alert, issue an automated configuration adjustment to stabilize connectivity of the appliance, or provide personalized guidance to the customer through a customer engagement platform. In some embodiments, the one or more fourth AI components in the fourth tier are configured to perform immediate range connectivity prediction for quality of service. In some embodiments, the distributed utility intelligence architecture further comprises a fifth tier of one or more fifth AI components, wherein the fifth tier is configured to monitor electrical data of one or more of: an electrical substation, a power plant, or a transmission line.

In some aspects, the present disclosure provides a system for distributed utility intelligence. In some embodiments, the system comprises a first AI component configured to monitor electrical data of a utility network. In some embodiments, the system comprises a second AI component configured to monitor electrical data of a transformer within the utility network. In some embodiments, the system comprises a third AI component configured to monitor electrical data of a service point corresponding to the transformer. In some embodiments, the system comprises a fourth AI component configured to monitor electrical data of an appliance located at the service point. In some embodiments, the first AI component is configured to direct activity of the second, third, and fourth AI components. In some embodiments, the second AI component is configured to direct activity of the third and fourth AI components. In some embodiments, the third AI component is configured to direct activity of the fourth AI component.

In some aspects, the present disclosure provides a method for managing a utility network. In some embodiments, the method comprises: (a) monitoring electrical data of a utility network using one or more first AI components; (b) monitoring electrical data of a transformer within the utility network using one or more second AI components; (c) monitoring electrical data of a service point corresponding to the transformer using one or more third AI components; and (d) monitoring electrical data of an appliance located at the service point using one or more fourth AI components. In some embodiments, the one or more first AI components comprise a first hierarchical tier that directs activity of the one or more second AI components, the one or more third AI components, and the one or more fourth AI components. In some embodiments, the one or more second AI components comprise a second hierarchical tier that directs activity of the one or more third AI components and the one or more fourth AI components. In some embodiments, the one or more third AI components comprise a third hierarchical tier that directs activity of the one or more fourth AI components. In some embodiments, the one or more fourth AI components comprise a fourth hierarchical tier. In some embodiments, one or more of the one or more first AI components, the one or more second AI components, the one or more third AI components, or the one or more fourth AI components comprise a processing unit and a sensory interface unit. In some embodiments, the processing unit comprises an AI model that performs a utility operation function. In some embodiments, the sensory interface unit provides utility sensor data to the processing unit. In some embodiments, the processing unit processes the utility sensor data with the AI model to perform the utility operation function. In some embodiments, the sensory interface unit uses one or more of: an electrical parameter, a network parameter, an environmental parameter, or a state parameter. In some embodiments, the sensory interface unit comprises a sensor interface layer, a signal processing layer, an event detection layer, a context enrichment layer, and a communication layer. In some embodiments, the sensor interface layer comprises a hardware-specific driver for data acquisition. In some embodiments, the signal processing layer comprises a digital signal processing algorithm configured to perform data transformation. In some embodiments, the event detection layer performs pattern matching or threshold monitoring to detect network events. In some embodiments, the AI model comprises a neural network model. In some embodiments, the method further comprises performing a parameter compression technique to reduce a size of the neural network model. In some embodiments, the method further comprises refining the AI model based on performance. In some embodiments, the method further comprises refining, using federated learning, one or more of: the one or more first AI components, the one or more second AI components, the one or more third AI components, or the one or more fourth AI components. In some embodiments, the method further comprises performing elastic weight consolidation. In some embodiments, the method further comprises performing knowledge distillation regularization. In some embodiments, information flows upward from the fourth tier to the third tier, from the third tier to the second tier, or from the second tier to the first tier. In some embodiments, information flows downward from the first tier to the second tier, from the second tier to the third tier, or from the third tier to the fourth tier. In some embodiments, information flows horizontally between one AI component and another AI component in a same tier. In some embodiments, information flows across tiers that are not directly connected. In some embodiments, the method further comprises the use of one or more of: a grid stability model, an asset health model, a consumption pattern model, a network resilience model, a resource optimization model, or a customer experience model. In some embodiments, the method further comprises the use of a generative AI agent. In some embodiments, the generative AI agent autonomously generates a software tool to address an operational gap identified during continuous grid monitoring. In some embodiments, a processing unit in the first tier comprises a neural network with at least 1,000,000 parameters. In some embodiments, the one or more first AI components in the first tier are deployed on an online grid management and monitoring platform. In some embodiments, the one or more first AI components in the first tier are configured to receive telemetry data from the one or more second AI components in the second tier. In some embodiments, the telemetry data from the one or more second AI components in the second tier comprises data about one or more of: transformer-level power flow, outage reports, or weather data. In some embodiments, the one or more first AI components in the first tier perform system-wide load pattern analysis of the utility network based on the telemetry data from the one or more second AI components in the second tier. In some embodiments, if the system-wide load pattern analysis forecasts an impending demand peak, the one or more first AI components in the first tier instruct the one or more second AI components in the second tier to implement a directive to handle the impending demand peak. In some embodiments, the directive is a load-shedding plan or demand-response initiative. In some embodiments, the one or more first AI components in the first tier correlate the data about transformer-level power flow with historical consumption data or with the weather data. In some embodiments, the one or more first AI components in the first tier predict demand spikes on the utility network and adjust system-wide distribution strategies on the network in response to the demand spikes. In some embodiments, the one or more first AI components in the first tier perform demand forecasting for the utility network. In some embodiments, the one or more first AI components in the first tier predict a load distribution on the utility network between about 24 hours and about 72 hours in advance of electricity use. In some embodiments, the one or more first AI components in the first tier detect a distribution-level anomaly affecting two or more circuits of the utility network. In some embodiments, the distribution-level anomaly comprises simultaneous voltage fluctuations across the two or more circuits that are outside of typical usage patterns of the utility network. In some embodiments, if the distribution-level anomaly is detected, the one or more first AI components in the first tier do one or more of: alert a utility operator, dispatch an automated alert, isolate an affected segment, or initiate a further diagnostic process. In some embodiments, the one or more first AI components in the first tier perform long-range load forecasting for resource planning. In some embodiments, a processing unit in the second tier comprises a neural network with between 1,000 parameters and 100,000 parameters. In some embodiments, the one or more second AI components in the second tier are deployed on one or more distribution transformer smart hubs corresponding to the transformer of the utility network. In some embodiments, the one or more second AI components in the second tier are configured to receive telemetry data from the one or more third AI components in the third tier. In some embodiments, the telemetry data from the one or more third AI components in the third tier comprises one or more of: data of real-time voltage levels, data of current flow, data of harmonics, data of transformer temperature, data of vibration, or data of load distribution. In some embodiments, the one or more second AI components in the second tier perform local electrical characteristic analysis using the data of load distribution and the data of transformer temperature. In some embodiments, if the one or more second AI components in the second tier detect a temperature anomaly or a transformer overloading, the one or more second AI components in the second tier implement a control directive on the transformer of the utility network. In some embodiments, the method further comprises using the control directive to do one or more of: dynamically adjust tap changer settings, redistribute local load, or adjust a local circuit parameter. In some embodiments, the local electrical characteristic analysis performed using the data of load distribution and the data of transformer temperature is used to predict potential transformer overheating of the transformer of the utility network. In some embodiments, the one or more second AI components in the second tier detect a transformer-level anomaly of the transformer of the utility network. In some embodiments, the transformer-level anomaly is a rapid increase in transformer vibration or a temperature spike without a corresponding load change of the transformer of the utility network. In some embodiments, if the transformer-level anomaly is detected, the one or more second AI components in the second tier do one or more of: generate a maintenance work order, initiate local load redistribution to mitigate risk, or communicate with the one or more first AI components in the first tier. In some embodiments, the one or more second AI components in the second tier perform medium-range equipment health prediction for maintenance planning on the transformer of the utility network. In some embodiments, a processing unit in the third tier comprises a neural network with between 100 parameters and 999 parameters. In some embodiments, the one or more third AI components in the third tier are deployed on one or more smart meters at the service point. In some embodiments, the one or more third AI components in the third tier collect customer usage data at the service point at regular intervals. In some embodiments, the customer usage data comprises one or more of: kilowatt-hour (kWh) consumption, a voltage dip or spike, an outage, or a demand profile. In some embodiments, the regular intervals are 5-minute increments, 15-minute increments, or 30-minute increments. In some embodiments, the one or more third AI components in the third tier use the customer usage data to detect abnormal electricity usage at the service point as compared to historical usage patterns. In some embodiments, if the abnormal electricity usage at the service point is detected, the one or more third AI components in the third tier do one or more of: notify the one or more second AI components in the second tier, flag data from the service point for increased monitoring, or log event details for utility records. In some embodiments, the one or more third AI components in the third tier perform short-range consumption prediction for load balancing. In some embodiments, a processing unit in the fourth tier comprises an inference model with fewer than 100 parameters. In some embodiments, the one or more fourth AI components in the fourth tier are deployed on one or more in-home or business wireless routers. In some embodiments, the one or more fourth AI components in the fourth tier detect degraded Wi-Fi telemetry of the appliance, if present. In some embodiments, the method further comprises optimizing usage of the appliance or the one or more in-home or business wireless routers based on telemetry from the appliance or the one or more in-home or business wireless routers. In some embodiments, the one or more fourth AI components in the fourth tier detect a usage anomaly of the appliance, if present. In some embodiments, if the usage anomaly of the appliance is detected, the one or more fourth AI components in the fourth tier do one or more of: issue a user-level alert, issue an automated configuration adjustment to stabilize connectivity of the appliance, or provide personalized guidance to the customer through a customer engagement platform. In some embodiments, the one or more fourth AI components in the fourth tier perform immediate range connectivity prediction for quality of service. In some embodiments, the method further comprises further monitoring electrical data of an electrical substation, a power plant, or a transmission line, using a fifth tier of one or more fifth AI components.

In some aspects, the present disclosure provides an AI component for managing a utility network. In some embodiments, the AI component comprises a processing unit configured to execute an AI model; and a sensory interface unit configured to provide utility sensor data to the processing unit. In some embodiments, the processing unit is configured to process the utility sensor data with the AI model to produce instructions for utility operations.

The present application provides systems and methods for a distributed intelligence architecture for utility network management that embeds artificial intelligence (AI) capabilities throughout the physical infrastructure. This distributed intelligence architecture may allow for real-time sensing, analysis, and response of the utility network while maintaining coordinated system-wide optimization.

In some cases, conventional enterprise artificial intelligence (AI) approaches may concentrate processing in centralized cloud environments. The architecture disclosed herein may distribute AI capabilities across four hierarchical tiers of the utility network. These hierarchical tiers may comprise a strategic intelligence tier (e.g., a cloud/enterprise tier), a tactical intelligence tier (e.g., a distribution equipment tier), an operational intelligence tier (e.g., a metering tier), or an experience intelligence tier (e.g., a customer premises tier). This multi-tiered approach may enable real-time decision-making at appropriate network levels while maintaining system-wide coordination. The architecture may comprise specialized cognitive and perception components tailored for utility-specific functions, which may be distributed throughout the physical network topology.

In some cases, the architecture disclosed herein may enable capabilities such as predictive maintenance of distribution equipment, real-time power quality management, autonomous outage response, non-technical loss detection, dynamic mesh network optimization, or personalized customer energy insights.

### Examples of Architecture Components

In some cases, the distributed utility intelligence architecture disclosed herein may comprise a hierarchy of specialized components that may reflect the physical topology of the utility distribution network.

First, the architecture may comprise one or more fundamental processing entities analogous to neurons in a biological neural network. These fundamental processing entities may be referred to as “AI Cognition Units” (ACUs). Each ACU may implement a standardized execution environment with specialized utility-domain knowledge and decision-making capabilities.

Second, the architecture may comprise one or more sensory interfaces between the physical world and the cognitive system. These sensory interfaces may be referred to as “AI Perception Units” (APUs). APUs may collect, preprocess, and encode telemetry data for consumption by ACUs.

Third, the architecture may comprise a hardware integration layer. This hardware integration layer may comprise a standardized interface for deploying ACUs and APUs across diverse utility hardware platforms. These utility hardware platforms may include, but are not limited to, transformer monitors, smart meters, and customer premises equipment.

Fourth, the architecture may comprise application services. These application services may comprise user-facing software that may provide visibility into system operations, enable configuration, and deliver insights to utility operators and customers.

These four components may operate together as a cohesive system while maintaining independent functionality during communication disruptions. This may create a resilient intelligence fabric across the utility network.

### Examples of AI Cognition Units (ACUs)

In some cases, AI Cognition Units (ACUs) may comprise the core processing entities of the distributed intelligence architecture. The ACUs may implement domain-specific cognitive functions optimized for utility operations, with capabilities that may be tailored to their position within the network hierarchy. Each ACU may be configured to store and execute an AI model thereon. Each model may be distinct and with a different complexity depending on the class of ACU and its intended function.

### Examples of ACU Classes

In some cases, the ACUs may be deployed in a hierarchical structure with up to four distinct classes. The higher-level ACUs may direct the activity of the lower-level ACUs.

### Alpha-class ACUs

The highest level ACUs may be referred to as the “Alpha-class ACUs.” These ACUs may be deployed in cloud/enterprise infrastructure to process system-wide data and coordinate global strategies. The Alpha-class ACUs may comprise a memory allocation of between about 4 gigabytes (GB) and about 16 GB. The Alpha-class ACUs may use multi-core server-grade computer processing units (CPUs) or cloud tensor processing units (TPUs). The Alpha-class ACUs may utilize deep neural networks with millions of parameters. The Alpha-class ACUs may have a temporal scope of months to years. This long temporal scope may allow the Alpha-class ACUs to be used for long-term pattern analysis. The Alpha-class ACUs may be deployed on an online grid management and monitoring platform.

### Beta-class ACUs

The second highest level ACUs may be referred to as “Beta-class ACUs.” These ACUs may be deployed on distribution equipment to manage transformer-level cognition. The Beta-class ACUs may comprise a memory allocation of between about 512 megabytes (MB) and about 2 GB. The Beta-class ACUs may comprise multi-core embedded processors. The Beta-class ACUs may utilize medium-complexity neural networks with thousands of parameters. The Beta-class ACUs may have a temporal scope of days to weeks. This temporal scope may allow the Beta-class ACUs to be used for medium-term analysis. The Beta-class ACUs may be deployed on distribution transformer smart hubs.

### Gamma-class ACUs

The third highest level ACUs may be referred to as “Gamma-class ACUs.” These ACUs may be deployed on metering devices to process consumption patterns. The Gamma-class ACUS may comprise a memory allocation of between about 64 MB and about 256 MB. The Gamma-class ACUs may comprise low power microcontrollers. The Gamma-class ACUs may utilize lightweight neural networks with hundreds of parameters. The Gamma-class ACUs may have a temporal scope of hours to days. This temporal scope may allow the Gamma-class ACUs to perform short-term analysis. The Gamma-class ACUs may be deployed in smart meters in a mesh network.

### Delta-class ACUs

Finally, the lowest level ACUs may be referred to as “Delta-class ACUs.” These ACUs may be deployed on customer premises to optimize the user experience. The Delta-class ACUs may comprise a memory allocation of between about 128 MB and about 512 MB. The Delta-class ACUs may comprise router-grade system-on-chips (SoCs). The Delta-class ACUs may utilize simple inference models with minimal parameters. The Delta-class ACUs may have an immediate temporal response of seconds to hours. The Delta-class ACUs may deployed in in-home or business wireless routers.

### Examples of ACU Core Functions

In some cases, each ACU may implement several fundamental analytical functions, with specific implementations tailored to the ACU's class and operational domain.

### Contextual Analysis

Each ACU may use contextual analysis to interpret telemetry data within an appropriate operational context. The Alpha-class ACUs may perform system-wide load pattern analysis across the service territory. For example, the Alpha-class ACUs may receive aggregated telemetry from multiple Beta-class units. This aggregated telemetry may include, but is not limited to, data about transformer-level power flow (current, voltage, power factor), outage reports, or weather event logs across multiple service areas. The Alpha-class ACUs may perform system-wide load pattern analysis based on the telemetry data provided by the Beta-class units. For example, the Alpha-class ACUs may correlate transformer power flow telemetry with historical consumption data and weather telemetry. The Alpha-class ACUs may predict demand spikes and proactively adjust system-wide distribution strategies (e.g., rerouting power during storms or heatwaves). In some cases, the Alpha-class ACUs may perform demand forecasting. The Alpha-class ACUs may be configured to predict load distributions between about 24 and about 72 hours in advance with a high accuracy. This demand forecasting would be performed based on transformer telemetry and weather information.

The Beta-class ACUs may perform analysis of local electrical characteristics for specific transformer circuits. The Beta-class ACUs may receive transformer-level telemetry from Gamma-class units. This transformer-level telemetry may include, but is not limited to, data about real-time voltage levels, current flow, harmonics, transformer temperature, vibration, or load distribution from connected Gamma-class units (smart meters). The Beta-class ACUs may conduct local electrical characteristic analysis by monitoring transformer load versus temperature telemetry. For example, if the transformer temperature steadily rises while load remains stable, the Beta-class ACUs may predict imminent transformer overheating. This may allow the system to prompt preventive maintenance or load reallocation before an outage occurs.

The Gamma-class ACUs may perform individual consumption pattern analysis for a specific service point. The Gamma-class ACUs may collect detailed consumer usage data (e.g., kWh consumption, voltage dips/spikes, outages, or demand profiles) at regular intervals (e.g., 5-minute increments, 15-minute increments, or 30-minute increments). The Gamma-class ACUs may process individual customer consumption patterns to detect abnormal usage telemetry. For example, the Gamma-class ACUs may be configured to detect a sudden, sustained spike in consumption without a corresponding increase in household occupancy, which may potentially indicate energy theft, faulty wiring, or equipment malfunction. This may then prompt an investigation alert.

The Delta-class ACUs may perform household usage pattern analysis for a specific customer. The Delta-class ACUs may collect detailed telemetry on, for example, household appliance usage patterns, Wi-Fi signal quality from transformer monitor hubs, or real-time connectivity status. The Delta-class ACUs may analyze immediate usage patterns to detect context-specific anomalies, such as degraded Wi-Fi telemetry (e.g., signal strength, packet loss) coinciding with periods of high electrical usage. This may allow for real-time optimization of local connectivity and appliance scheduling. For example, the system may notify customers to stagger appliance use or adjust router settings for better connectivity.

### Anomaly Detection

In some cases, the system may perform anomaly detection. The system may be configured to identify deviations from established patterns requiring attention.

The Alpha-class ACUs may be configured to detect distribution-level anomalies affecting multiple circuits. For example, the Alpha-class ACUs may be configured to detect simultaneous abnormal voltage fluctuations across multiple transformer circuits, which may potentially indicate a coordinated cyber-attack or widespread equipment malfunction. After detecting a distribution-level anomaly, the Alpha-class ACUs may be configured to immediately dispatch automated alerts, isolate affected segments, or initiate further diagnostic routines while informing utility operators.

The Beta-class ACUs may be configured to detect transformer-level anomalies affecting multiple customers. For example, the Beta-class ACUs may be configured to identify unexpected rapid increases in transformer vibration or unusual temperature spikes without corresponding load changes. These anomalies may indicate imminent transformer failure. The Beta-class ACUs may be configured to generate maintenance work orders, initiate local load redistribution to mitigate imminent risk, or notify the Alpha-class ACUs for broader situational awareness.

The Gamma-class ACUs may be configured to detect meter-level anomalies affecting specific service points. For example, the Gamma-class ACUs may be configured to discover significant and sudden changes in electricity consumption compared to historical usage patterns, which may be due to unauthorized connections (energy theft) or equipment failure. The Gamma-class ACUs may be configured to send immediate notification to the Beta-class ACUs for local investigation, flag the meter data for heightened monitoring, or log the event details for utility records. In some cases, the Gamma-class ACUs may be configured to identify at-risk equipment at least 24 hours before failure, based on sensor fusion and anomaly detection.

The Delta-class ACUs may be configured to detect connection-level anomalies affecting customer experience. For example, the Delta-class ACUs may be configured to detect persistent Wi-Fi interference or sudden, repetitive disconnections coinciding with specific appliance usage. For example, the Delta-class ACUs may be configured to detect high-frequency switching of HVAC systems affecting home network stability. In the case of a connection-level anomaly, the Delta-class ACUs may be configured to, for example, issue user-level alerts and automated configuration adjustments to stabilize connectivity, or provide personalized guidance through customer engagement platforms.

### Predictive Modeling

In some cases, the different classes of ACUs may perform predictive modeling, e.g., forecasting future states based on current trends and historical patterns. For example, the Alpha-class ACUs may perform long-range load forecasting for resource planning. In another example, the Beta-class ACUs may perform medium-range equipment health prediction for maintenance planning. In another example, the Gamma-class ACUs may perform short-range consumption prediction for load balancing. In another example, the Delta-class ACUs may perform immediate-range connectivity prediction for quality of service.

### Decision Formulation

In some cases, the different classes of ACUs may perform decision formulation, e.g., generating actionable directives based on analyzed data. The Alpha-class ACUs may perform system-wide optimization strategies. For example, after system-wide load pattern analysis forecasts an impending demand peak due to extreme heat conditions, the Alpha-class ACU may formulate strategic decisions to balance power distribution across multiple regions. The Alpha-class ACU may instruct the Beta-class ACUs to implement, for example, load-shedding plans or demand-response initiatives. The Alpha-class ACU may broadcast operational targets and coordinated strategies across affected Beta-class units, adjusting transformer set-points and directing resources to mitigate potential overload scenarios at a system-wide scale.

The Beta-class ACUs may perform transformer-level control directives. For example, if transformer-level analytics detect temperature anomalies or overloading, the Beta-class ACU may formulate immediate control directives, such as dynamically adjusting tap changer settings or redistributing local load. The Beta-class ACU may send real-time instructions to connected Gamma-class ACUs (e.g., smart meters). The Beta-class ACU may adjust local circuit parameters to immediately relieve stress on the transformer, thereby preventing outages or equipment damage.

The Gamma-class ACUs may perform meter-level configuration adjustments. For example, when anomalous usage patterns indicative of potential energy theft or meter faults are detected, the Gamma-class ACU may decide on configuration adjustments or flag the meter for inspection. The Gamma-class ACU may initiate directives for heightened telemetry sampling frequency, activate remote meter testing protocols, or trigger investigative alerts to local Beta-class ACUs and customer service teams for on-site verification.

The Delta-class ACUs may optimize connection-level optimization parameters. For example, if home network connectivity telemetry reveals repeated interference or performance issues, the Delta-class ACU may formulate optimization directives such as switching Wi-Fi channels, managing device prioritization, or providing tailored customer recommendations (e.g., scheduling high-consumption appliances during off-peak network usage times). The Delta-class ACU may execute immediate router adjustments automatically. The Delta-class ACU may provide personalized notifications and actionable guidance directly to the homeowner through customer engagement interfaces.

### Learning Adaptation

In some cases, the system may modify internal models based on outcomes and feedback.

The Alpha-class ACUs may perform fleet-wide model improvements based on aggregate performance. This may be done by continuously collecting and evaluating system-wide telemetry data, outcomes of previously formulated strategies, or long-term performance metrics. The Alpha-class ACUs may use federated learning and knowledge distillation methods. The Alpha-class ACUs may refine deep neural networks to better predict load patterns, optimize resource allocation, or adjust strategic planning. For example, if the system-wide load forecasting model consistently underestimates electricity consumption during heat waves, the Alpha-class ACU may aggregate this feedback, retrain or fine-tune the predictive models with updated historical data, or distribute improved versions down the hierarchy.

The Beta-class ACUs may perform circuit-specific adaptations based on local conditions. This may be done by monitoring transformer-level performance and comparing predicted equipment health or load management outcomes against actual results. The system may adjust medium-complexity neural network models through periodic local updates via federated learning from Alpha-class insights. For example, if the Beta-class ACU repeatedly predicts transformer overheating scenarios inaccurately (too early or too late), it may capture these discrepancies, adapt parameters within its neural networks, and adjust predictive thresholds to enhance future accuracy. This may directly benefit transformer reliability.

The Gamma-class ACUs may perform meter-specific adaptations based on usage patterns. This may be done by evaluating actual customer usage telemetry against predicted short-term consumption forecasts. The Gamma-class ACUs may employ lightweight neural networks to fine-tune detection of anomalies or energy theft patterns based on real outcomes at individual meter points. For example, if a Gamma-class ACU incorrectly flags a household's genuine energy spike (e.g., a new electric vehicle charger installation) as potential theft, it may update its model by incorporating confirmed false-positive feedback, adapting detection thresholds and recognition patterns to minimize future false alarms.

The Delta-class ACUs may perform user-specific adaptations based on connectivity patterns. The Delta-class ACUs may perform these user-specific adaptations based on observing the immediate effectiveness of local connectivity optimizations and user engagement interactions. The Delta-class ACUs may implement rapidly-updating minimal-parameter inference models that may reflect changing home network conditions and customer preferences. For example, if automatic Wi-Fi channel adjustments significantly improve user experience during evening hours, the Delta-class ACU may reinforce these positive outcomes by adapting its local decision model to proactively schedule similar optimizations during future periods of expected high network activity.

### Examples of ACU Implementation

In some cases, each ACU may operate within a containerized runtime environment that may ensure consistent execution regardless of underlying hardware. This standardized environment may comprise secure execution context, e.g., an isolated runtime preventing unauthorized access or manipulation. The standardized environment may comprise resource management, e.g., the dynamic allocation of processing, memory, and storage resources. The standardized environment may comprise a model registry, e.g., a local repository of AI models appropriate for the ACU's domain. The standardized environment may comprise parameter store, e.g., persistent storage for configuration and learned parameters. The standardized environment may comprise a communication interface, e.g., standardized methods for inter-ACU communication. The standardized environment may comprise a hardware abstraction layer, which may adapt to specific capabilities of hosting hardware. The containerized approach may enable consistent behavior across heterogeneous hardware while optimizing for the specific capabilities of each deployment platform.

### Examples of AI Perception Units (APUs)

In some cases, the system may comprise what may be called “AI Perception Units” (APUs). APUs may serve as the sensory interface between the physical world and the AI network. The APUs may collect, preprocess, and encode sensory/physical data for consumption by ACUs.

### Examples of APU Core Functions

In some cases, the APUs may perform signal acquisition. The APU may capture raw telemetry from physical sensors in the utility grid network. The APU may use electrical parameters (e.g., voltage, current, power factor, harmonics), network parameters (e.g., signal strength, bandwidth, latency, packet loss), environmental parameters (e.g., temperature, humidity, vibration), or state parameters (e.g., switch positions, alarm conditions, tampering indicators).

The APUs may perform signal processing. The APU may transform raw signals into usable measurements. The APU may perform filtering (e.g., noise reduction, outlier removal). The APU may perform normalization (e.g., scaling, offset correction). The APU may perform aggregation (e.g., temporal or spatial aggregation). The APU may perform feature extraction (e.g., frequency analysis, waveform characterization). The APUs may perform event detection. The APU may be configured to identify significant state changes requiring immediate attention. The APU may be configured to detect threshold crossings (e.g., out-of-range values). The APU may be configured to detect state transitions (e.g., on/off, connected/disconnected). The APU may be configured to detect pattern breaks (e.g., deviation from expected behavior). The APU may be configured to detect temporal anomalies (e.g., timing irregularities).

The APUs may perform contextual tagging. The APUs may be configured to add metadata about collection conditions and quality. The APUs may use temporal context (e.g., timestamp, sequence information). The APUs may use spatial context (e.g., location, proximity to other sensors). The APUs may use quality metrics (e.g., confidence, accuracy, precision). The APUs may use operational context (e.g., normal operation, maintenance mode, recovery mode).

The APUs may use secure transmission. The APUs may package and encrypt preprocessed data for delivery to ACUs. The APUs may use compression (lossless or lossy depending on criticality). The APUs may use prioritization (e.g., urgency-based message scheduling). The APUS may use authentication (e.g., source verification). The APUs may use encryption (e.g., privacy and integrity protection).

### Examples of APU Implementation

In some cases, APUs may be implemented using a layered architecture that may separate hardware-specific interfacing from logical processing. The APU may comprise a sensor interface layer. The sensor interface layer may comprise hardware-specific drivers for data acquisition. The APU may comprise a signal processing layer. The APU may comprise digital signal processing algorithms for data transformation. The APU may comprise an event detection layer. The APU may use pattern matching and threshold monitoring for event identification. The APU may comprise a context enrichment layer. The APU may use metadata attachment and correlation. The APU may comprise a communication layer. The APU may use secure packaging and transmission of processed data. This layered approach may enable consistent behavior across diverse sensing hardware while optimizing for the specific characteristics of each sensor type.

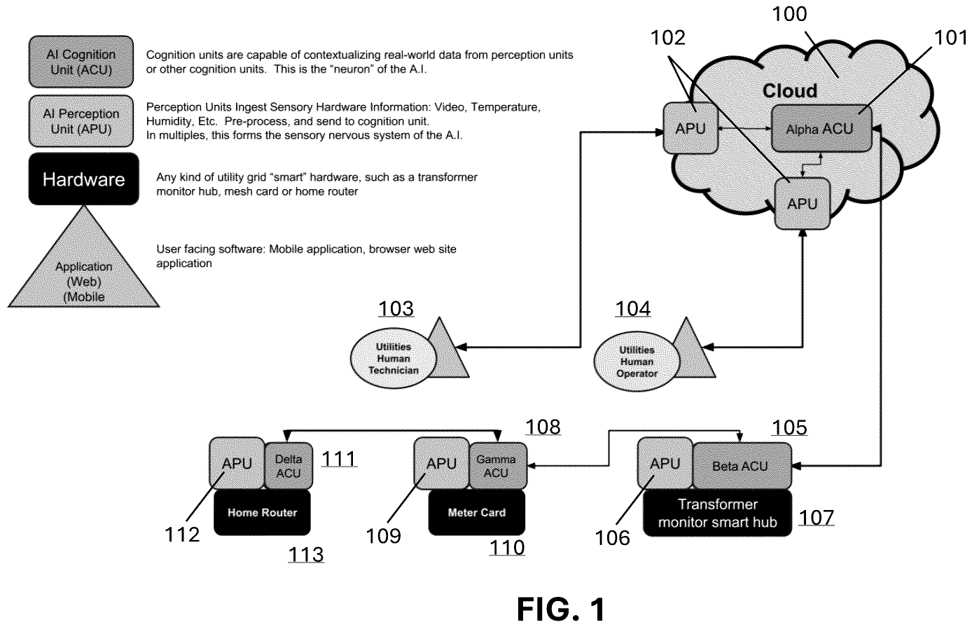

FIG. 1 shows a schematic of the relationships between each of the four tiers and their corresponding APUs and ACUs. An Alpha ACU 101 may be located in the cloud 100 and have corresponding APUs 102 that communicate with human utilities technicians 103 and operators 104. The Beta ACUs 105 and their corresponding APUs 106 may be located on transformer monitor smart hubs 107. The Gamma ACUs 108 and their corresponding APUs 109 may be located on meter cards 110. Finally, the Delta ACUs 111 and their corresponding APUs 112 may be located on home routers 113.

### Examples of Knowledge Transfer and Learning Architecture

In some cases, the systems and methods disclosed herein may incorporate innovative mechanisms for distributing intelligence across the system while maintaining cohesive operation.

### Knowledge Distillation Pipeline

The systems and methods disclosed herein may implement a knowledge distillation pipeline. The knowledge distillation pipeline may enable large-scale models at higher tiers to efficiently transfer knowledge to smaller models at lower tiers. This may allow the system to maintain intelligence capabilities while respecting hardware constraints.

For example, the systems and methods disclosed herein may use a teacher-student model framework. Complex models at higher tiers (e.g., the Alpha-class ACUs) may act as “teachers” that may train simplified models for deployment on resource-constrained devices (e.g., the Beta, Gamma, and Delta-class ACUs).

### Alpha-class ACUs (Teacher Models)

The Alpha-class ACUs may utilize deep neural networks with millions of parameters capable of analyzing extensive historical datasets, real-time telemetry, or predictive indicators to generate precise system-wide insights, forecasts, or strategic decisions. These highly complex models may generate labeled data and prediction outcomes. For example, the models may identify subtle voltage instability patterns or predict transformer failures months in advance. The Alpha-class ACUs may distill this knowledge into smaller datasets, model outputs, or behavioral patterns suitable for training simplified, resource-constrained student models.

### Beta-class ACUs (Distribution Equipment Tier Student Models)

The Beta-class ACUs may use medium-complexity neural networks with thousands of parameters. These medium-complexity neural networks may be hosted on transformer monitoring hardware. In an example, the Alpha-class teacher models may identify complex correlations between transformer load, temperature, and long-term asset health trends. The Alpha-class units may provide distilled data and simplified inference rules to the Beta-class student models. The Beta-class units may then accurately detect local transformer anomalies and may initiate timely preventive actions without needing extensive computational resources.

### Gamma-class ACUs (Metering Tier Student Models)

The Gamma-class ACUs may use lightweight neural networks with hundreds of parameters. These lightweight neural networks may be embedded directly within utility meters. The lightweight neural networks may be limited by microcontroller processing and memory constraints.

In an example, the Alpha-class teacher models may analyze detailed historical customer consumption data to identify subtle consumption anomalies indicative of potential energy theft or meter malfunction. The Alpha-class teacher models may distill critical detection rules and patterns into simplified student models for Gamma-class ACUs. This may allow for efficient, local anomaly detection at scale.

### Delta-class ACUs (Customer Premises Tier Student Models)

The Delta-class ACUs may comprise minimal-parameter inference models optimized for router-grade hardware. This may allow for rapid, context-specific adjustments at customer locations. In an example, the Alpha-class teacher models may analyze extensive datasets to identify optimal Wi-Fi configurations, device prioritization strategies, or user behavior patterns correlated with superior customer experiences. Distilled knowledge from the Alpha-class models may be transferred as simplified inference rules to Delta-class student models. This may enable these routers to instantly respond and optimize household network connectivity in real-time.

### Parameter Compression

Knowledge distillation may employ parameter compression techniques to reduce the size of neural network models while preserving critical functionality. Pruning may systematically remove less important connections in neural networks. Quantization may reduce the precision of weights from 32-bit floating point to 8-bit integers. Low-rank factorization may decompose weight matrices into smaller components.

### Domain-specific Optimization

Knowledge distillation processes may be tailored to utility-specific tasks to maximize performance on targeted functions. For example, power quality analysis optimization may be performed for Beta-class ACUs. Consumption pattern recognition may be performed for Gamma-class ACUs. User experience personalization may be performed for Delta-class ACUs.

### Federated Learning Implementation

The system may support continual improvement through federated learning. The federated learning may respect privacy and bandwidth constraints. Client-side training may be performed. Edge devices (e.g., the Beta, Gamma, and Delta-class ACUs) may perform local model updates based on local observations. Secure aggregation may be performed. Parameter updates may be securely aggregated without exposing raw data. Differential privacy may be implemented. Random noise may be added to updates to provide privacy guarantees. Selective parameter sharing may be implemented. Only essential parameter updates may be transmitted in order to conserve bandwidth.

### Catastrophic Forgetting Prevention

The architecture may employ mechanisms to prevent loss of critical capabilities during model updates. Elastic weight consolidation may be performed, so that important parameters are protected during updates. Knowledge distillation regularization may be performed. New models may be trained to match outputs of previous models on critical tasks. Task-specific parameter isolation may be performed. Parameters critical for specific tasks may be protected during updates to other functionalities.

### Examples of Communication Architecture

In some cases, the distributed utility intelligence architecture may implement a sophisticated communication framework that may enable coordinated operation while minimizing bandwidth usage and ensuring resilience to network disruptions.

### Communication Patterns

Several communication patterns may be implemented.

Hierarchical aggregation may be implemented. The system may comprise upward flow of summarized information from lower to higher ACU tiers. For example, individual customer usage patterns or connectivity status may flow from the Delta tier to the Gamma tier. Aggregated consumption data or meter health status may flow from the Gamma tier to the Beta tier. Circuit-level electrical characteristics or asset health metrics may flow from the Beta tier to the Alpha tier. Finally, system-wide performance analytics or optimization opportunities may flow from the Alpha tier to the Enterprise tier.

Directive distribution may be implemented. The system may comprise downward flow of instructions, parameters, and constraints. For example, strategic objectives or system-wide constraints may flow from the Enterprise tier to the Alpha tier. Operational targets or optimization parameters may flow from the Alpha tier to the Beta tier. Configuration settings or monitoring thresholds may flow from the Beta tier to the Gamma tier. User experience parameters or connectivity optimizations may flow from the Gamma tier to the Delta tier.

Peer collaboration may be implemented. The system may comprise horizontal exchange of information and coordination of signals between ACUs at the same hierarchical level. For example, cross-regional coordination for system balancing may be exchanged between Alpha ACUs. Adjacent circuit coordination for load balancing may be exchanged between Beta ACUs. Mesh network optimization among nearby meters may be exchanged between Gamma ACUs. Local area network optimization among customer devices may be exchanged between Delta ACUs.

Broadcast alerting may be implemented. The system may comprise system-wide distribution of critical information requiring immediate attention. For example, safety-critical alerts for potential hazardous conditions may be distributed system-wide. Security alerts for potential intrusion attempts may be distributed system-wide. Major outage notifications affecting multiple circuits may be distributed system-wide. Severe weather advisories affecting system operations may be distributed system-wide.

Targeted consultation may be implemented. The system may comprise direct communication between specific ACUs across hierarchical levels. For example, Alpha units may communicate to Gamma units regarding direct investigation of specific meter anomalies. Beta units may communicate to Delta units regarding direct investigation of service quality issues. Gamma units may communicate to Alpha units regarding escalation of potential energy theft detection. Delta units may communicate to Beta units regarding reporting of customer-observed power quality issues.

### Resilient Messaging Framework

The system may implement a standardized approach to information exchange that may ensure reliable communication even during adverse conditions.

Message prioritization may be implemented. Messages may be categorized based on operational significance. For example, messages may be categorized into emergency (e.g., immediate delivery required for safety), critical (e.g., rapid delivery required for reliability), important (e.g., timely delivery required for optimization), or routine (e.g., eventual delivery sufficient for records).

Transport adaptation may be implemented. Communication pathways may be dynamically selected based on availability. For example, a primary path (e.g., a preferred communication channel during normal operation), an alternate path (e.g., a secondary channel when the primary is unavailable), a fallback path (e.g., a minimal capability channel for emergency communications), or an indirect path (e.g., message relay through intermediate nodes when direct communication is impossible) may be selected.

Store-and-forward persistence may be implemented. Messages may be retained during communication disruptions. For example, short-term holding (e.g., a brief retention during temporary disruptions) may be implemented. Medium-term storage (e.g., extended retention during significant outages) may be implemented. Long-term archiving (e.g., permanent storage of critical information) may be implemented. Prioritized forwarding (e.g., ordered delivery based on message significance when connectivity is restored) may be implemented.

Security mechanisms may be implemented to protect communication integrity and confidentiality. A security mechanism may comprise authentication (e.g., verification of message sources). A security mechanism may comprise authorization (e.g., validation of sender permissions). A security mechanism may comprise encryption (e.g., protection of message contents). A security mechanism may comprise integrity validation (e.g., detection of message tampering). A security mechanism may comprise replay prevention (e.g., protection against duplicate message injection).

### Examples of Utility-specific Cognitive Models

In some cases, the system may employ specialized cognitive processing designed specifically for utility infrastructure management.

### Domain-specific Intelligence Models

In some cases, the system may comprise a grid stability model. The grid stability model may comprise a specialized predictive system that may anticipate electrical grid instabilities before they manifest by recognizing subtle precursor patterns across distributed measurements. The grid stability model may perform voltage stability prediction using phase angle measurements. The grid stability model may perform load balancing optimization across transformer circuits. The grid stability model may perform dynamic protection settings adjustment based on grid conditions. The grid stability model may perform frequency response prediction for renewable integration.

The grid stability model may be primarily executed by the Alpha-class ACUs (Cloud/Enterprise Tier). The Alpha-class ACUs may perform system-wide predictive analysis and strategic decision-making. They may leverage comprehensive, long-term telemetry datasets to anticipate large-scale grid instabilities.

The grid stability model may be secondarily executed, with a limited scope, by the Beta-class ACUs. The Beta-class ACUs may provide localized transformer circuit stability insights for immediate corrective actions. These insights may be informed by higher-tier analytics.

### Asset Health Model

In some cases, the system may comprise an asset health model. The asset health model may comprise a comprehensive analytical system that may synthesize multiple indicators to assess equipment condition, predict maintenance needs, or optimize service life. The asset health model may perform transformer thermal modeling using top and bottom oil temperatures. The asset health model may perform insulation degradation prediction based on loading history. The asset health model may perform contact wear estimation using operation counts and current levels. The asset health model may perform vibration pattern analysis for mechanical anomaly detection.

The asset health model may be primarily executed by the Beta-class ACUs (e.g., the distribution equipment tier/distribution transformer smart hubs). The Beta-class ACUs may perform real-time monitoring and health assessment of transformers and distribution equipment. The Beta-class ACUs may directly analyze equipment telemetry (e.g., temperature, vibration, electrical load) to predict maintenance needs locally.

The asset health model may be supported in its execution by the Alpha-class ACUs. The Alpha-class ACUs may perform aggregated asset health data analytics for broader, long-term asset management strategies across service areas.

### Consumption Pattern Model

In some cases, the system may comprise a consumption pattern model. The consumption pattern model may comprise an advanced behavioral model that may identify normal versus abnormal usage patterns, detect non-technical losses, or forecast demand across different timescales. The consumption pattern model may perform customer segmentation based on consumption characteristics. The consumption pattern model may perform anomaly detection for potential energy theft. The consumption pattern model may perform load disaggregation for appliance-level insights. The consumption pattern model may perform short-term load forecasting for operational planning.

The consumption pattern model may be primarily executed by the Gamma-class ACUs (e.g., the metering tier/mesh cards in utility meters). The Gamma-class ACUs may perform individual meter-level consumption analysis, may detect short-term usage anomalies (e.g., energy theft or appliance malfunction) and may forecast localized demand patterns.

The consumption pattern model may be supportively executed by the Alpha-class ACUs. The Alpha-class ACUs may perform aggregation and broader forecasting at the system level to assist in grid resource allocation and planning.

### Network Resilience Model

In some cases, the system may comprise a network resilience model. The network resilience model may comprise a sophisticated simulation capability that may continuously evaluate alternate configurations to maximize service reliability during both normal and adverse conditions. The network resilience model may comprise self-healing network reconfiguration planning. The network resilience model may comprise failure impact prediction or mitigation. The network resilience model may comprise resource allocation optimization during restoration. The network resilience model may comprise preventive isolation planning for threatened segments.

### Resource Optimization Model

In some cases, the system may comprise a resource optimization model. The resource optimization model may comprise an integrated planning system that may balance operational objectives, maintenance requirements, or customer needs within resource constraints. The resource optimization model may perform workforce scheduling based on maintenance priorities. The resource optimization model may perform inventory management tied to predictive maintenance. The resource optimization model may perform capital planning informed by asset health projections. The resource optimization model may perform energy resource dispatch optimization.

The resource optimization model may be primarily executed by the Alpha-class ACUS (cloud/enterprise tier). The Alpha-class ACUs may coordinate resource allocation, workforce scheduling, inventory management, or long-term capital planning using comprehensive system-wide data. The resource optimization model may be exclusively managed at the Alpha-class tier due to the complexity and strategic nature of resource planning.

### Customer Experience Model

In some cases, the system may comprise a customer experience model. The customer experience model may comprise a personalized engagement system that may adapt service delivery, communication, or interaction based on individual preferences or behaviors. The customer experience model may perform usage pattern recognition for personalized insights. The customer experience model may perform communication preference optimization. The customer experience model may perform service quality perception modeling. The customer experience model may perform proactive notification timing optimization.

The customer experience model may be primarily executed by the Delta-class ACUs (customer premises tier/wireless routers). The customer experience model may provide real-time personalization and immediate adaptation to customer behavior or preferences. The customer experience model may optimize local user experience based on individual telemetry data.

The customer experience model may be supportively executed by the Gamma-class ACUs. The Gamma-class ACUs may provide customer consumption insights to assist Delta-class units. The Alpha-class ACUs may perform high-level aggregation or analytics for personalized recommendations. The high-level aggregation or analytics may be distributed to lower tiers.

### Examples of Grid Resilience Framework

In some cases, the architecture may incorporate a comprehensive resilience framework to ensure continued operation during adverse conditions.

### Autonomous Safety Architecture

In some cases, the system may implement multiple protective mechanisms to ensure safe operation regardless of specific implementation.

The system may implement operational envelope enforcement. Operational envelope enforcement may comprise a system of absolute constraints that may prevent ACUs from issuing commands that would place the utility infrastructure in unsafe operating conditions. The constraints may include electrical parameter limits (e.g., voltage, current, frequency), thermal limits (e.g., transformer temperature, conductor temperature), mechanical limits (e.g., tap changer operations, switch operations), or resource limits (e.g., workforce capacity, inventory levels).

The operational envelope enforcement may be primarily executed by the Beta-class ACUs (e.g., transformer smart hubs). The Beta-class ACUs may enforce real-time operational constraints at transformer circuits, such as maximum temperature or electrical load.

The operational envelope enforcement may be secondarily executed by the Alpha-class ACUs. The Alpha-class ACUs may define global operational constraints. These global operational constraints may be periodically updated based on broader system conditions. The Alpha-class ACUs may relay these directives down to the Beta-class units.

### Command Verification

In some cases, the system may perform command verification. Command verification may comprise a multi-stage validation process that may evaluate proposed actions against safety models before implementation. Command verification may comprise syntax validation to ensure well-formed commands. Command verification may comprise range validation to ensure parameters are within safe limits. Command verification may comprise state validation to ensure commands are appropriate for current conditions. Command verification may comprise sequence validation to ensure proper operational order.

Command verification may be primarily executed by the Beta-class ACUs. The Beta-class ACUs may perform real-time validation of local operational commands (e.g. transformer adjustments, switching actions). This real-time validation may ensure that parameters remain within safety thresholds before actual implementation.

Command verification may be supportively executed by the Alpha-class ACUs. The Alpha-class ACUs may perform high-level strategic command validation. The Alpha-class ACUs may provide secondary checks and approvals for more impactful or complex directives that may influence multiple lower-tier ACUs.

### Fallback Configurations

In some cases, the system may comprise fallback configurations. The fallback configurations may comprise a comprehensive library of safe configurations for different infrastructure components. These safe configurations may be applied during uncertain or compromised conditions. The fallback configurations may comprise default protection settings for compromised transformers. The fallback configurations may comprise minimal connectivity configurations for compromised networks. The fallback configurations may comprise conservative operating parameters for uncertain conditions. The fallback configurations may comprise graceful degradation modes for resource limitations.

The fallback configurations may be primarily executed by the Beta-class ACUs. The Beta-class ACUs may rapidly apply predefined fallback configurations (e.g., default protection settings for transformers, minimal safe load scenarios) when anomalies or disruptions occur at local levels.

The fallback configurations may be secondarily executed by the Gamma-class ACUs. The Gamma-class ACUs may implement fallback settings at metering points during compromised conditions (e.g., disabling non-critical meter functions). The fallback configurations may be secondarily executed by the Delta-class ACUs. The Delta-class ACUs may apply fallback network configurations to maintain minimal connectivity and safe operations during local disruptions.

### Examples of Self-healing Mechanisms

In some cases, the system may implement specialized recovery capabilities.

### Automated Diagnostic Suite

In some cases, the system may comprise an automated diagnostic suite. The automated diagnostic suite may comprise a comprehensive collection of self-assessment tools. These self-assessment tools may identify compromised functions, corrupted data, or degraded performance within the ACU ecosystem. The self-assessment tools may comprise function testing for cognitive capabilities. The self-assessment tools may comprise data validation for stored state information. The self-assessment tools may comprise performance benchmarking for processing efficiency. The self-assessment tools may comprise communication testing for network connectivity.

### State Reconstruction

In some cases, the system may comprise capabilities for state reconstruction. A state reconstruction capability may be an advanced capability to rebuild operational awareness from fragmented information distributed across surviving ACUs following partial system failure. The state reconstruction capability may be capable of fragment collection from multiple sources. The state reconstruction capability may be capable of consistency validation across fragments. The state reconstruction capability may be capable of gap identification or interpolation. The state reconstruction capability may be capable of confidence scoring for reconstructed states.

### Capability Reallocation

In some cases, the system may be able to perform capability reallocation. The system may be capable of a dynamic redistribution of cognitive responsibilities that may shift functions from compromised to healthy ACUs based on available resources. This may include function criticality assessment, resource availability mapping, capability migration planning, or execution monitoring and verification.

### Customer Engagement Platform

In some cases, the architecture may comprise a sophisticated customer engagement platform that may leverage the distributed intelligence to enhance customer experience.

### Personalized Energy Insights

In some cases, the system may comprise usage pattern analysis. The system may provide detailed analysis of customer energy usage patterns. The system may perform appliance-level disaggregation, behavioral pattern recognition, comparative analysis with similar customers, or anomaly detection for unusual usage.

In some cases, the system may comprise personalized recommendations. The system may provide customized energy advice for each customer. The system may provide energy efficiency recommendations tailored to specific usage patterns. The system may provide time-of-use optimization guidance. The system may provide distributed energy resources (DER) adoption insights based on individual consumption profiles. The system may provide demand response opportunity recommendations.

In some cases, the system may comprise predictive billing. The system may provide forward-looking insights on energy costs. The system may provide bill forecasting based on current usage and rates. The system may provide usage goal tracking toward customer-set targets. The system may provide rate plan optimization based on usage patterns. The system may provide a budget alert system for proactive notification.

In some cases, the customer experience model may autonomously handle at least 50%, at least 55%, at least 60%, at least 65%, at least 70%, at least 75%, at least 80%, at least 85%, at least 90%, or at least 95% of billing and outage inquiries based on utility-specific knowledge.

### DER Integration Support

In some cases, the system may provide solar and storage optimization. The system may provide maximization of customer-owned distributed energy resource value. The system may perform solar performance monitoring in real-time. The system may perform storage dispatch optimization based on rates and grid conditions. The system may perform export value maximization through intelligent timing. The system may perform self-consumption optimization for maximum economic benefit.

In some cases, the system may comprise electric vehicle integration. The system may provide support for EV charging management. The system may comprise smart charging scheduling based on rates and needs. The system may comprise charge status monitoring in real-time. The system may comprise vehicle-to-grid opportunity assessment. The system may comprise charging cost analysis or optimization.

In some cases, the system may comprise virtual power plant participation. The system may provide support for aggregated DER participation in grid services. The system may provide program eligibility assessment for customer assets. The system may provide event notification and participation management. The system may provide performance feedback or compensation tracking. The system may provide opt-out mechanisms for customer control.

### Examples of Self-Generating Tool Architecture

In some cases, the system may comprise a distributed intelligence system wherein AI agents may autonomously identify operational gaps or inefficiencies during continuous 24/7 grid monitoring. The AI agents may autonomously generate specialized software tools to address said gaps, e.g., without human intervention. In some cases, the agents may include about: one agent, two agents, five agents, ten agents, twenty five agents, fifty agents, one hundred agents, five hundred agents, one thousand agents, five thousand agents, ten thousand agents, fifty thousand agents, one hundred thousand agents, a million agents, ten million agents, one hundred million agents, one billion agents, etc. In some cases, there may be one or more agents assigned per node in a power grid or network. For example, the nodes may include endpoints (e.g., houses, factories, businesses, etc.) of a power grid or network or midpoints (e.g., transformers, substations, etc.) of a power grid or network.

In some cases, the system may comprise a tool synthesis engine configured to generate domain-specific utilities, scripts, analytical functions, and integration modules in response to patterns detected during autonomous operation or explicit requests from authorized utility stakeholders or operators. Tool generation may be triggered by recognition of novel scenarios that may not be adequately addressed by existing capabilities. These novel scenarios may include, but are not limited to, emerging grid conditions, new equipment types, or previously unobserved failure modes.

In some cases, self-generated tools may undergo multi-stage verification prior to production deployment. This multi-stage verification may include, but is not limited to, static code analysis, sandboxed execution testing, safety constraint validation, or performance benchmarking.

In some cases, the system may comprise a staged promotion process. This staged promotion process may comprise isolated simulation testing against historical grid data. The staged promotion process may comprise shadow-mode operation alongside existing tools. The staged promotion process may comprise limited deployment on non-critical network segments. The staged promotion process may comprise full production rollout with continuous monitoring.

In some cases, the system may comprise automated rollback mechanisms. These automated rollback mechanisms may detect degraded performance, safety violations, or anomalous behavior. The system may revert to previously-validated tool versions.

In some cases, the system may comprise safety and reliability mechanisms. The system may comprise hard-coded operational boundaries that may constrain self-generated tools from affecting safety-critical grid functions (e.g., protection settings, emergency response, life-safety systems) without explicit human authorization.

In some cases, the system may comprise cryptographic signing and audit logging of all autonomously generated code. This may enable full traceability and compliance verification.

In some cases, the system may generate federated review protocols. Tool modifications proposed by edge-tier intelligence (e.g., the Beta/Gamma/Delta ACUs) may require validation by higher-tier intelligence (e.g., the Alpha-class ACUs) before deployment.

In some cases, the system may comprise stakeholder-initiated tool generation. The system may comprise a natural language interface enabling utility operators to request new capabilities. For example, a user may be able to enter “create a tool that monitors transformer loading patterns during heat events and alerts when thermal limits approach.” In some cases, the interface may confirm scope, constraints, and success criteria before initiating tool generation.

In some cases, the system may comprise a collaborative iteration loop that may allow stakeholders to review, test, or refine generated tools before approval for operational use.

### Method for Implementing Distributed Utility Intelligence

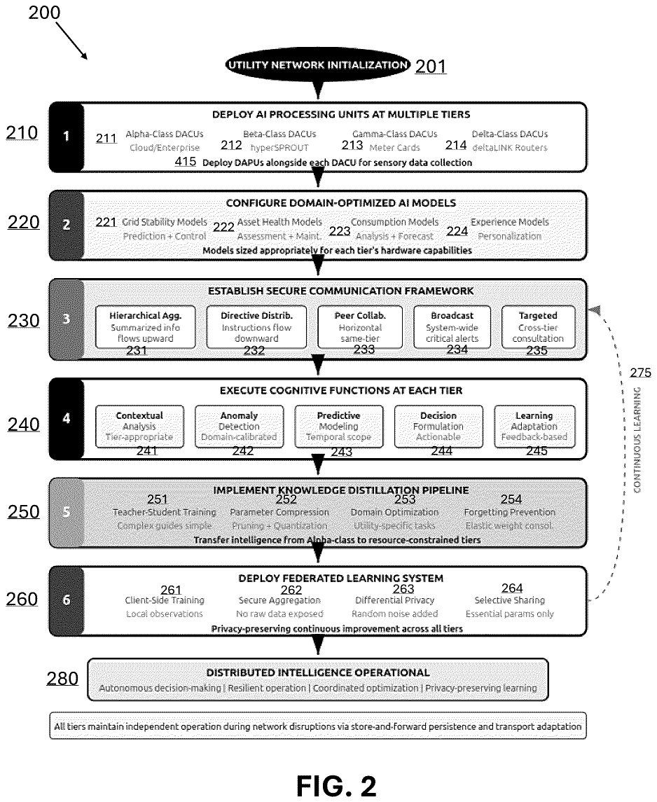

FIG. 2 shows a method flowchart illustrating operations performed to implement distributed intelligence in a utility network using the ACUs and APUs described. The method 200 may begin at initialization operation 201, wherein a utility network may be prepared for deployment of distributed intelligence capabilities. It is worth noting that in some cases, the method 200 may be performed in order (e.g., according to the arrows descending in FIG. 2). However, in other cases, the method 200 may be performed in any order. In some cases, one or more operations of the method 200 may be repeated (e.g., iteratively). In some cases, one or more operations of the method 200 may be omitted. In some cases, one or more operations may be added to the method 200. In some cases, one or more operations of the method 200 may be conditionally ordered, performed, omitted, repeated, or added (e.g., conditional on other operations of the method 200 or on other external factors).

The initialization operation 201 may trigger the deployment of processing units at operation 210. At operation 210, the method may deploy artificial intelligence processing units at multiple tiers of the utility network topology. Operation 210 may comprise operations 211, 212, 213, 214, and 215.

Operation 211 may comprise Alpha-Class ACU deployment. Operation 211 may comprise deploying Alpha-class ACUs in cloud/enterprise infrastructure for system-wide data processing and global strategy coordination, with about 2 GB to about 16 GB memory allocation and server-grade processing capability.

Operation 212 may comprise Beta-Class ACU deployment. Operation 212 may comprise deploying Beta-class ACUs on distribution equipment (e.g., smarthubs) for transformer-level cognition and local control, with about 512 MB to about 2 GB memory allocation and embedded processor capability.

Operation 213 may comprise Gamma-Class ACU deployment. Operation 213 may comprise deploying Gamma-class ACUs on metering devices (e.g., mesh cards) for consumption pattern processing and customer-specific analytics, with 64-256 MB memory allocation and low-power microcontroller capability.

Operation 214 may comprise Delta-Class ACU deployment. Operation 214 may comprise deploying Delta-class ACUs on customer premises equipment (e.g., routers) for user experience optimization and personalized insights, with 128-512 MB memory allocation and router-grade SoC capability.

Operation 215 may comprise APU co-deployment. Operation 215 may comprise deploying APUs (APUs) alongside each ACU class for sensory data collection, preprocessing, and secure transmission to cognition units.

Upon completion of operation 210, the method may proceed to operation 220.

At operation 220, the method may configure each processing unit with artificial intelligence models optimized for its operational domain and hardware capabilities. Operation 220 may comprise operations 212, 222, 223, and 224.

Operation 221 may comprise grid stability models. Operation 221 may comprise configuring models for grid stability prediction and control, with temporal scope appropriate to each tier's function (long-range at Alpha, medium-range at Beta, short-range at Gamma, immediate at Delta).

Operation 222 may comprise asset health models. Operation 222 may comprise configuring models for asset health assessment and maintenance optimization, with domain-specific focus on system-wide assets at Alpha, transformer equipment at Beta, meter devices at Gamma, and customer equipment at Delta.

Operation 223 may comprise consumption pattern models. Operation 223 may comprise configuring models for consumption pattern analysis and forecasting, with scope ranging from service territory at Alpha to individual households at Delta.

Operation 224 may comprise experience personalization models. Operation 224 may comprise configuring models for customer experience personalization and network resilience evaluation, with model complexity sized appropriately for each tier's hardware constraints.

Upon completion of operation 220, the method may proceed to operation 230.

At operation 230, the method may establish a secure communication framework between processing units that may enable coordination while supporting independent operation. Operation 230 may comprise operations 231, 232, 233, 234, and 235.

Operation 231 may comprise a hierarchical aggregation configuration. Operation 231 may comprise configuring upward flow of summarized information from lower to higher ACU tiers, including Delta-to-Gamma customer patterns, Gamma-to-Beta consumption data, Beta-to-Alpha circuit characteristics, or Alpha-to-Enterprise system analytics.

Operation 232 may comprise directive distribution configuration. Operation 232 may comprise configuring downward flow of instructions, parameters, and constraints from higher to lower tiers, including strategic objectives, operational targets, configuration settings, or user experience parameters.

Operation 233 may comprise peer collaboration configuration. Operation 233 may comprise configuring horizontal exchange of information and coordination of signals between ACUs at the same hierarchical level for cross-regional coordination, adjacent circuit balancing, mesh network optimization, or local area network optimization.

Operation 234 may comprise broadcast alerting configuration. Operation 234 may comprise configuring system-wide distribution of critical information requiring immediate attention, including safety-critical alerts, security alerts, major outage notifications, or severe weather advisories.

Operation 235 may comprise targeted consultation configuration. Operation 235 may comprise configuring direct communication pathways between specific ACUs across hierarchical levels for anomaly investigation, service quality assessment, theft detection escalation, or power quality issue reporting.

Upon completion of operation 230, the method may proceed to operation 240.

At operation 240, the method may execute cognitive functions at each tier of the distributed intelligence architecture. Operation 240 may comprise five parallel cognitive processes, shown in operations 241, 242, 243, 244, and 245. Operation 241 may comprise contextual analysis execution. Operation 241 may comprise executing contextual analysis tailored to each unit's position in the network hierarchy. For the Alpha-class, the system may perform system-wide load pattern analysis across the service territory. For the Beta-class, the system may perform local electrical characteristics analysis for specific transformer circuits. For the Gamma-class, the system may perform individual consumption pattern analysis for specific service points. For the Delta-class, the system may perform household usage pattern analysis for specific customers.

Operation 242 may comprise anomaly detection execution. Operation 242 may comprise executing anomaly detection calibrated to each unit's specific operational domain. For the Alpha-class, the system may detect distribution-level anomalies affecting multiple circuits. For the Beta-class, the system may detect transformer-level anomalies affecting multiple customers. For the Gamma-class, the system may detect meter-level anomalies affecting specific service points. For the Delta-class, the system may detect connection-level anomalies affecting customer experience.

Operation 243 may comprise predictive modeling execution. Operation 243 may comprise executing predictive modeling with temporal scope appropriate to each unit's function. For the Alpha-class, the system may perform long-range load forecasting for resource planning (months to years). For the Beta-class, the system may perform medium-range equipment health prediction for maintenance planning (days to weeks). For the Gamma-class, the system may perform short-range consumption prediction for load balancing (hours to days). For the Delta-class, the system may perform immediate-range connectivity prediction for quality of service (seconds to hours).

Operation 244 may comprise decision formulation execution. Operation 244 may comprise executing decision formulation for generation of actionable directives. For the Alpha-class, the system may perform system-wide optimization strategies. For the Beta-class, the system may perform transformer-level control directives. For the Gamma-class, the system may perform meter-level configuration adjustments. For the Delta-class, the system may perform connection-level optimization adjustments.

Operation 245 may comprise learning adaptation execution. Operation 245 may comprise executing learning adaptation that modifies internal models based on outcomes and feedback. For the Alpha-class, the system may perform fleet-wide model improvements based on aggregate performance. For the Beta-class, the system may perform circuit-specific adaptations based on local conditions. For the Gamma-class, the system may perform meter-specific adaptations based on usage patterns. For the Delta-class, the system may perform user-specific adaptations based on connectivity patterns.

Upon completion of operation 240, the method may proceed to operation 250.

At operation 250, the method may implement a knowledge distillation pipeline that may transfer intelligence from resource-rich to resource-constrained environments. Operation 250 may comprise operations 251, 252, 253, and 254.

Operation 251 may comprise teacher-student model training. Operation 251 may comprise implementing a teacher-student model framework, where complex models at higher tiers (Alpha-class ACUs) guide the training of simplified models for deployment on resource-constrained devices (Beta, Gamma, and Delta-class ACUs).

Operation 252 may comprise parameter compression execution. Operation 252 may comprise executing parameter compression techniques to reduce model size while preserving critical functionality. For example, pruning may systematically remove less important connections in neural networks. Quantization may reduce precision of weights from 32-bit floating point to 8-bit integers. Low-rank factorization may decompose weight matrices into smaller components.

Operation 253 may comprise domain-specific optimization. Operation 253 may comprise executing domain-specific optimization to maximize performance on targeted utility functions. For example, power quality analysis optimization may be performed for Beta-class ACUs. Consumption pattern recognition may be performed for Gamma-class ACUs. User experience personalization may be performed for Delta-class ACUs.

Operation 254 may comprise catastrophic forgetting prevention. Operation 254 may comprise implementing mechanisms to prevent loss of critical capabilities during model updates. For example, one of these mechanisms may comprise elastic weight consolidation to protect important parameters during updates. Knowledge distillation regularization may be performed. New models may be trained to match outputs of previous models on critical tasks. Task-specific parameter isolation may be performed to protect parameters critical for specific tasks during updates to other functionalities.

Upon completion of operation 250, the method may proceed to operation 260.

At operation 260, the method may deploy a federated learning system that may enable continuous improvement while respecting bandwidth and privacy constraints. Operation 260 may comprise operations 261, 262, 263, and 264.

Operation 261 may comprise client-side training deployment. Operation 261 may comprise deploying client-side training where edge devices (Beta, Gamma, and Delta-class ACUs) perform local model updates based on local observations without transmitting raw data.

Operation 262 may comprise secure aggregation implementation. Operation 262 may comprise implementing secure aggregation, where parameter updates may be securely combined without exposing individual device data or customer information.

Operation 263 may comprise differential privacy applications. Operation 263 may comprise applying differential privacy by adding calibrated random noise to parameter updates to provide mathematical privacy guarantees for customer data protection.

Operation 264 may comprise selective parameter sharing configurations. Operation 264 may comprise configuring selective parameter sharing. Only essential parameter updates may be transmitted to conserve bandwidth, prioritizing updates that provide the greatest improvement to system-wide model performance.

The method may implement a continuous learning feedback loop 275, returning to operation 240 for ongoing cognitive function execution and model improvement. The feedback loop 275 may enable dynamic adaptation to changing grid conditions and customer behavior, continuous refinement of predictive models through federated learning aggregation, responsive adjustment to new anomaly patterns and threat signatures, or progressive improvement of decision-making accuracy across all tiers.

Upon successful execution of operations 210 through 275, the distributed utility intelligence architecture may achieve operational state 280. Operational state 280 may be characterized by autonomous decision-making, wherein each tier makes appropriate decisions within its domain without requiring constant central coordination. Operational state 280 may be characterized by resilient operation, wherein all tiers maintain independent functionality during network disruptions via store-and-forward persistence and transport adaptation. Operational state 280 may be characterized by coordinated optimization. System-wide optimization may be achieved through hierarchical aggregation and directive distribution. Operational state 280 may be characterized by privacy-preserving learning. Continuous improvement may occur without exposing sensitive customer data.

### System for Implementing Distributed Utility Intelligence

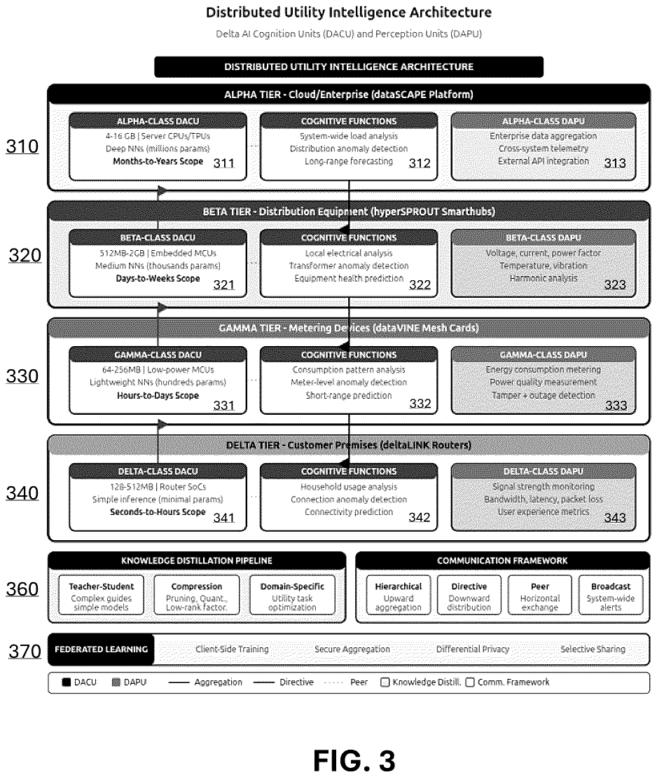

FIG. 3 shows a system architecture diagram 300 depicting the distributed utility intelligence architecture comprising hierarchical AI processing units deployed across multiple tiers of utility network topology.

The upper portion of FIG. 3 illustrates the Alpha Tier 310, which may comprise cloud and enterprise infrastructure deployed on the system platform for system-wide data processing and global strategy coordination.

The Alpha Tier 310 may comprise the Alpha-Class ACU 311. The Alpha-Class ACU 311 may comprise a memory allocation of between about 4 GB and about 16 GB RAM for large-scale model execution. The Alpha-Class ACU 311 may comprise multi-core server-grade CPUs or cloud TPUs. The Alpha-Class ACU 311 may comprise deep neural networks with millions of parameters. The Alpha-Class ACU 311 may comprise long-term pattern analysis spanning months to years.

The cognitive functions 312 implemented by Alpha-Class ACUs may include system-wide load pattern analysis across the entire service territory; distribution-level anomaly detection affecting multiple circuits; long-range load forecasting for resource planning; or system-wide optimization strategies and fleet-wide model improvements.

The Alpha-Class APU 313 may provide enterprise data aggregation from subordinate tiers; cross-system telemetry collection and correlation; external data integration from weather, market, and regulatory sources; or API gateway processing for third-party system interfaces.

The second tier of FIG. 3 illustrates the Beta Tier 320, which may comprise distribution equipment deployed on smarthubs for transformer-level cognition and local control.

The Beta-Class ACU 321 may comprise a memory allocation of between about 512 MB and about 2 GB RAM. The Beta-Class ACU may comprise multi-core embedded processors. The Beta-Class ACU may comprise medium-complexity neural networks with thousands of parameters. The Beta-Class ACU may perform medium-term analysis spanning days to weeks.

The cognitive functions 322 implemented by the Beta-Class ACUs may include, for example, local electrical characteristics analysis for specific transformer circuits; transformer-level anomaly detection affecting multiple customers; medium-range equipment health prediction for maintenance planning; or transformer-level control directives and circuit-specific adaptations.

The Beta-Class APU 323 may collect voltage, current, and power factor measurements; temperature and vibration monitoring data; harmonic analysis for power quality assessment; or asset health telemetry for predictive maintenance.

The third tier of FIG. 3 illustrates the Gamma Tier 330, which comprises metering devices deployed on mesh cards for consumption pattern processing and customer-specific analytics. The Gamma-Class ACU 331 may comprise a memory allocation of about 64 MB to about 256 MB RAM. The Gamma-Class ACU may comprise low-power microcontrollers. The Gamma-Class ACU may comprise lightweight neural networks with hundreds of parameters. The Gamma-Class ACU may comprise short-term analysis spanning hours to days.

The cognitive functions 332 implemented by Gamma-Class ACUs may include, but are not limited to, individual consumption pattern analysis for specific service points; meter-level anomaly detection for theft and tampering identification; short-range consumption prediction for load balancing; or meter-level configuration adjustments and usage pattern adaptations.

The Gamma-Class APU 333 may collect energy consumption metering with interval data; power quality measurement at the service point; tamper detection through physical and electrical monitoring; or outage detection and restoration confirmation.

The fourth tier of FIG. 3 illustrates the Delta Tier 340, which may comprise customer premises equipment deployed on routers for user experience optimization and personalized insights.

The Delta-Class ACU 341 may comprise a memory allocation of about 128 MB to about 512 MB RAM. The Delta-Class ACU 341 may comprise a processing capability of router-grade System-on-Chips (SoCs). The Delta-Class ACU 341 may comprise simple inference models with minimal parameters. The Delta-Class ACU 341 may comprise an immediate response spanning seconds to hours.

The cognitive functions 342 implemented by Delta-Class DACUs may include, but are not limited to, household usage pattern analysis for specific customers; connection-level anomaly detection affecting customer experience; immediate-range connectivity prediction for quality of service; or connection-level optimization parameters and user-specific adaptations.

The Delta-Class APU 343 may collect network signal strength measurements; bandwidth, latency, and packet loss metrics; device connectivity status across the home network; or user experience metrics for service quality assessment.

FIG. 3 also illustrates communication pathways between tiers implementing multiple communication patterns.

Upward-flowing arrows may represent hierarchical aggregation of summarized information. Delta to Gamma upward arrows may represent individual customer usage patterns and connectivity status. Gamma to Beta upward arrows may represent aggregated consumption data and meter health status. Beta to Alpha upward arrows may represent circuit-level electrical characteristics and asset health metrics. Alpha to Enterprise upward arrows may represent system-wide performance analytics and optimization opportunities.

Downward-flowing arrows may represent directive distribution of instructions and parameters. Enterprise to Alpha downward arrows may represent strategic objectives and system-wide constraints. Alpha to Beta downward arrows may represent operational targets and optimization parameters. Beta to Gamma downward arrows may represent configuration settings and monitoring thresholds. Gamma to Delta downward arrows may represent user experience parameters and connectivity optimizations.

Horizontal dashed lines may represent peer collaboration between units at the same hierarchical level. Alpha-to-Alpha lines may represent cross-regional coordination for system balancing. Beta-to-Beta lines may represent adjacent circuit coordination for load balancing. Gamma-to-Gamma lines may represent mesh network optimization among nearby meters. Delta-to-Delta lines may represent local area network optimization among customer devices.

The lower-left portion of FIG. 3 illustrates the knowledge distillation pipeline 360, which may enable transfer of intelligence from resource-rich to resource-constrained environments. The knowledge distillation pipeline 360 may comprise a teacher-student framework. Complex models at higher tiers (Alpha-class ACUs) may act as “teachers” that may train simplified models for deployment on resource-constrained devices (Beta, Gamma, and Delta-class ACUs).

The knowledge distillation pipeline 360 may comprise parameter compression. Knowledge distillation may employ parameter compression techniques including, but not limited to, pruning (e.g., systematically removing less important connections in neural networks), quantization (e.g., reducing precision of weights from 32-bit floating point to 8-bit integers); or low-rank factorization (e.g., decomposing weight matrices into smaller components).

The knowledge distillation pipeline 360 may comprise domain-specific optimization. Knowledge distillation processes may be tailored to utility-specific tasks. These utility-specific tasks may include, but are not limited to, power quality analysis optimization for Beta-class ACUs; consumption pattern recognition for Gamma-class ACUs; or user experience personalization for Delta-class DACUs.

The bottom portion of FIG. 3 illustrates the federated learning system 370 enabling continuous improvement while respecting privacy and bandwidth constraints. The federated learning system may comprise client-side training, wherein edge devices perform local model updates based on local observations. The federated learning system may comprise secure aggregation, wherein parameter updates are securely aggregated without exposing raw data. The federated learning system may comprise differential privacy, wherein random noise is added to updates to provide privacy guarantees. The federated learning system may comprise selective parameter sharing, wherein only essential parameter updates are transmitted to conserve bandwidth.

### Examples of Machine Learning Techniques

In some cases, the systems, the methods, the computer-readable media, and the techniques disclosed herein may leverage or be applied to one or more machine learning techniques. For example, the systems, the methods, the computer-readable media, and the techniques disclosed herein may be used to provide control to machine learning models. In some cases, machine learning (ML) may provide predictive analytics for a distributed utility intelligence architecture. A hierarchy of specialized ML models may be used to assist in performing utility network management. These ML models may be embedded throughout the physical utility infrastructure.

In some cases, machine learning (ML) may generally involve identifying and recognizing patterns in existing data in order to facilitate making predictions for subsequent data. ML may include an ML model (which may include, for example, an ML algorithm). Machine learning, whether analytical or statistical in nature, may provide deductive or abductive inference based on real or simulated data. The ML model may be a trained model. ML techniques may comprise one or more supervised, semi-supervised, self-supervised, or unsupervised ML techniques. For example, an ML model may be a trained model that is trained through supervised learning (e.g., various parameters are determined as weights or scaling factors). ML may comprise one or more of regression analysis, regularization, classification, dimensionality reduction, ensemble learning, meta learning, association rule learning, cluster analysis, anomaly detection, deep learning, or ultra-deep learning. ML may comprise: k-means, k-means clustering, k-nearest neighbors, learning vector quantization, linear regression, non-linear regression, least squares regression, partial least squares regression, logistic regression, stepwise regression, multivariate adaptive regression splines, ridge regression, principal component regression, least absolute shrinkage and selection operation (LASSO), least angle regression, canonical correlation analysis, factor analysis, independent component analysis, linear discriminant analysis, multidimensional scaling, non-negative matrix factorization, principal components analysis, principal coordinates analysis, projection pursuit, Sammon mapping, t-distributed stochastic neighbor embedding, AdaBoosting, boosting, gradient boosting, bootstrap aggregation, ensemble averaging, decision trees, conditional decision trees, boosted decision trees, gradient boosted decision trees, random forests, stacked generalization, Bayesian networks, Bayesian belief networks, naïve Bayes, Gaussian naïve Bayes, multinomial naïve Bayes, hidden Markov models, hierarchical hidden Markov models, support vector machines, encoders, decoders, auto-encoders, stacked auto-encoders, perceptrons, multi-layer perceptrons, artificial neural networks, feedforward neural networks, convolutional neural networks, recurrent neural networks, residual neural networks, physics-informed neural networks, long short-term memory, deep belief networks, deep Boltzmann machines, deep convolutional neural networks, deep recurrent neural networks, large language models, transformer models, vision transformers, or generative adversarial networks.

Training the ML model may include, in some cases, selecting one or more untrained data models to train using a training data set. The selected untrained data models may include any type of untrained ML models for supervised, semi-supervised, self-supervised, or unsupervised machine learning. The selected untrained data models may be specified based upon input (e.g., user input) specifying relevant parameters to use as predicted variables or other variables to use as potential explanatory variables. For example, the selected untrained data models may be specified to generate an output (e.g., a prediction) based upon the input. Conditions for training the ML model from the selected untrained data models may likewise be selected, such as limits on the ML model complexity or limits on the ML model refinement past a certain point. The ML model may be trained (e.g., via a computer system such as a server) using the training data set. In some cases, a first subset of the training data set may be selected to train the ML model. The selected untrained data models may then be trained on the first subset of training data set using appropriate ML techniques, based upon the type of ML model selected and any conditions specified for training the ML model. In some cases, due to the processing power requirements of training the ML model, the selected untrained data models may be trained using additional computing resources (e.g., cloud computing resources). Such training may continue, in some cases, until at least one aspect of the ML model is validated and meets selection criteria to be used as a predictive model.

In some cases, one or more aspects of the ML model may be validated using a second subset of the training data set (e.g., distinct from the first subset of the training data set) to determine accuracy and robustness of the ML model. Such validation may include applying the ML model to the second subset of the training data set to make predictions derived from the second subset of the training data. The ML model may then be evaluated to determine whether performance is sufficient based upon the derived predictions. The sufficiency criteria applied to the ML model may vary depending upon the size of the training data set available for training, the performance of previous iterations of trained models, or user-specified performance requirements. If the ML model does not achieve sufficient performance, additional training may be performed. Additional training may include refinement of the ML model or retraining on a different first subset of the training dataset, after which the new ML model may again be validated and assessed. When the ML model has achieved sufficient performance, in some cases, the ML may be stored for present or future use. The ML model may be stored as sets of parameter values or weights for analysis of further input (e.g., further relevant parameters to use as further predicted variables, further explanatory variables, further user interaction data, etc.), which may also include analysis logic or indications of model validity in some instances. In some cases, a plurality of ML models may be stored for generating predictions under different sets of input data conditions. In some cases, the ML model may be stored in a database (e.g., associated with a server).

### Examples of Computer Systems

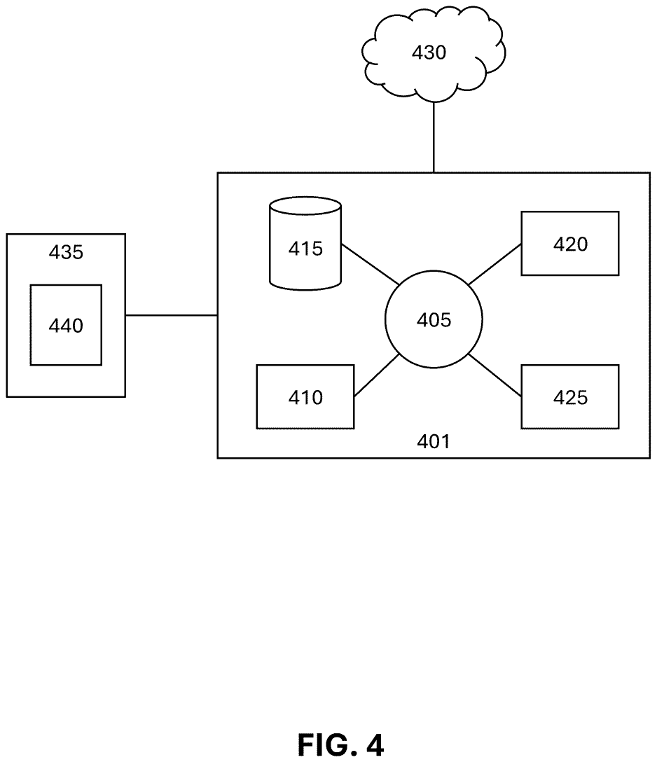

In some cases, the present disclosure provides computer systems that are programmed to implement methods of the disclosure. FIG. 4 shows a computer system that is programmed or otherwise configured to provide a distributed intelligence architecture for utility network management. The computer system 401 can regulate various aspects of the present disclosure, for example, controlling a hierarchy of artificial intelligence agents that interact with a utility network. The computer system 401 can be an electronic device of a user or a computer system that is remotely located with respect to the electronic device.

The computer system 401 includes a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk), communication interface 420 (e.g., network adapter) for communicating with one or more other systems, and peripheral devices 425, such as cache, other memory, data storage or electronic display adapters. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computer system 401 can be operatively coupled to a computer network (“network”) 430 with the aid of the communication interface 420. The network 430 can be the Internet, an internet or extranet, or an intranet or extranet that is in communication with the Internet. The network 430 in some cases is a telecommunication or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are external to the computer system 401, such as located on a remote server that is in communication with the computer system 401 through an intranet or the Internet.

The computer system 401 can communicate with one or more remote computer systems through the network 430. For instance, the computer system 401 can communicate with a remote computer system of a user (e.g., a mobile device). Examples of remote computer systems include personal computers (e.g., portable PC), slate or tablet PC's (e.g., Apple® iPad, Samsung® Galaxy Tab), telephones, smart phones (e.g., Apple® iPhone, Android-enabled device, Blackberry®), or personal digital assistants. The user can access the computer system 401 via the network 430.

Methods as disclosed herein can be implemented by way of machine (e.g., computer processor) executable code stored on an electronic storage location of the computer system 401, such as, for example, on the memory 410 or electronic storage unit 415. The machine executable or machine readable code can be provided in the form of software. During use, the code can be executed by the processor 405. In some embodiments, the code can be retrieved from the storage unit 415 and stored on the memory 410 for ready access by the processor 405. In some embodiments, the electronic storage unit 415 can be excluded, and machine-executable instructions are stored on memory 410.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code or data. Many of these forms of computer readable media may be involved in carrying one or more sequences of one or more instructions to a processor for execution.

The computer system 401 can include or be in communication with an electronic display 435 that comprises a user interface (UI) 440 for providing, for example, a dashboard. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 405.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft . NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft SQL Server, mySQL, and Oracle. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash ActionScript, JavaScript, or Silverlight. In some embodiments, a web application is written to some extent in a server-side coding language such as Active Server Pages (ASP), ColdFusion, Perl, Java, JavaServer Pages (JSP), Hypertext Preprocessor (PHP), Python, Ruby, Tcl, Smalltalk, WebDNA, or Groovy. In some embodiments, a web application is written to some extent in a database query language such as Structured Query Language (SQL). In some embodiments, a web application integrates enterprise server products such as IBM Lotus Domino. In some embodiments, a web application includes a media player element. In various further embodiments, a media player element utilizes one or more of many suitable multimedia technologies including, by way of non-limiting examples, Adobe Flash, HTML 5, Apple QuickTime, Microsoft Silverlight, Java, and Unity.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network disclosed herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java, JavaScript, Pascal, Object Pascal, Python, Ruby, VB.NET, WML, and XHTML/HTML with or without CSS, or combinations thereof.

Suitable mobile application development environments are available from several sources. Commercially available development environments include, by way of non-limiting examples, Airplay SDK, alcheMo, Appcelerator, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android SDK, BlackBerry SDK, BREW SDK, Palm OS SDK, Symbian SDK, webOS SDK, and Windows Mobile SDK.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java, Lisp, Python, Visual Basic, and VB.NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of, by way of examples, image, cell state, protocol, and culture condition information. In various embodiments, suitable databases include, by way of non-limiting examples, relational databases, non-relational databases, object-oriented databases, object databases, entity-relationship model databases, associative databases, XML databases, document-oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based at least in part on one or more local computer storage devices.

While preferred embodiments of the present disclosure have been shown and disclosed herein, it will be obvious to those skilled in the art that such embodiments are provided by way of example only. It is not intended that the present disclosure be limited by the specific examples provided within the specification. While the embodiments of the present disclosure have been described with reference to the aforementioned specification, the descriptions and illustrations of the embodiments herein are not meant to be construed in a limiting sense. Numerous variations, changes, and substitutions will now occur to those skilled in the art without departing from the embodiments of the present disclosure. Furthermore, it shall be understood that all aspects of the present disclosure are not limited to the specific depictions, configurations or relative proportions set forth herein which depend upon a variety of conditions and variables. It should be understood that various alternatives to the embodiments of the present disclosure disclosed herein may be employed in practicing the embodiments of the present disclosure. It is therefore contemplated that the present disclosure shall also cover any such alternatives, modifications, variations or equivalents. It is intended that the following claims define the scope of the invention(s) and that methods and structures within the scope of these claims and their equivalents be covered thereby.

### Exemplary Embodiments

Among the exemplary embodiments are:
1. A distributed intelligence architecture for utility network management that embeds artificial intelligence capabilities throughout physical infrastructure, comprising: a hierarchy of specialized artificial intelligence processing units distributed across different tiers of utility network topology; a standardized communication framework enabling secure coordination between processing units while maintaining independent operation during communication disruptions; context-specific artificial intelligence models optimized for different utility operational domains and hardware capabilities; a knowledge distillation pipeline enabling transfer of intelligence from resource-rich to resource-constrained environments; and a federated learning system that enables continuous improvement while respecting bandwidth and privacy constraints.
2. In some embodiments, the hierarchy of specialized artificial intelligence processing units comprises: one or more alpha-class processing units deployed in cloud/enterprise infrastructure for system-wide data processing and global strategy coordination; one or more beta-class processing units deployed on distribution equipment for transformer-level cognition and local control; one or more gamma-class processing units deployed on metering devices for consumption pattern processing and customer-specific analytics; and one or more delta-class processing units deployed on customer premises for user experience optimization and personalized insights.
3. In some embodiments, each processing unit implements multiple cognitive functions, including: contextual analysis tailored to the position of the processing unit in the network hierarchy; anomaly detection calibrated to the specific operational domain; predictive modeling with temporal scope appropriate to the unit's function; decision formulation for generation of actionable directives; and learning adaptation that modifies internal models based on outcomes and feedback.
4. In some embodiments, the standardized communication framework implements multiple communication patterns, including: hierarchical aggregation for upward flow of summarized information; directive distribution for downward flow of instructions and parameters; peer collaboration for horizontal exchange between units at the same hierarchical level; broadcast alerting for system-wide distribution of critical information; and targeted consultation for direct communication between specific units across hierarchical levels.
5. In some embodiments, the context-specific artificial intelligence models include domain-specific intelligence models for: grid stability prediction and control; asset health assessment and maintenance optimization; consumption pattern analysis and forecasting; network resilience evaluation and optimization; resource allocation and scheduling; and customer experience personalization.
6. In some embodiments, the knowledge distillation pipeline implements mechanisms for: teacher-student model training where complex models guide the training of simplified models; parameter compression to reduce model size while preserving critical functionality; domain-specific optimization to maximize performance on targeted functions; federated learning to enable privacy-preserving distributed model improvement; catastrophic forgetting prevention to maintain critical capabilities during updates.
7. In some embodiments, the architecture further comprises a secure communication framework implementing: multi-layer security architecture with protections at device, network, and application levels; real-time threat detection using behavior-based, signature-based, and heuristic analysis; automated incident response capabilities for isolation, fallback, and self-healing; and security intelligence sharing across the distributed architecture.
8. In some embodiments, the architecture further comprises an advanced analytics engine providing: multi-horizon load forecasting for short, medium, and long-term planning; asset health prediction for proactive maintenance optimization; distributed energy resource integration forecasting and optimization; multi-modal anomaly detection with contextual classification; root cause analysis for automated fault diagnosis; and multi-objective optimization balancing reliability, cost, and environmental impact.
9. In some embodiments, the architecture further comprises a grid resilience framework implementing: systematic threat assessment and vulnerability mapping; dynamic protection settings that adjust based on current conditions; coordinated protection schemes across multiple protective devices; automated fault management for detection, location, isolation, and service restoration; dynamic network reconfiguration for loss minimization and constraint management; and adaptive microgrids capable of autonomous operation during grid disturbances.
10. In some embodiments, the architecture further comprises a customer engagement platform providing: personalized energy insights based on usage pattern analysis; predictive billing and budget management tools; multi-channel engagement options adapted to customer preferences; behavioral energy management using goals, gamification, and social comparison; distributed energy resource optimization for solar, storage, and electric vehicles; and virtual power plant participation support for aggregated grid services.
11. A method for implementing distributed intelligence in a utility network, comprising: deploying artificial intelligence processing units at multiple tiers of the utility network topology; configuring each processing unit with artificial intelligence models optimized for its operational domain and hardware capabilities; establishing a secure communication framework between processing units that enables coordination while supporting independent operation; implementing a knowledge distillation pipeline that transfers intelligence from resource-rich to resource-constrained environments; and deploying a federated learning system that enables continuous improvement while respecting bandwidth and privacy constraints.
12. In some embodiments, the method further comprises analyzing contextual data at each processing unit's appropriate level of the network hierarchy; detecting anomalies specific to each unit's operational domain; generating predictions with temporal scope appropriate to each unit's function; formulating decisions and actionable directives based on local and distributed intelligence; and adapting internal models based on outcomes and feedback.
13. In some embodiments, the method further comprises implementing multiple communication patterns between processing units, including: hierarchical aggregation of summarized information flowing upward; directive distribution of instructions and parameters flowing downward; peer collaboration through horizontal exchange between units at the same hierarchical level; broadcast alerting for system-wide distribution of critical information; and targeted consultation through direct communication between specific units across hierarchical levels.
14. In some embodiments, the method further comprises deploying domain-specific intelligence models for: grid stability prediction and control; asset health assessment and maintenance optimization; consumption pattern analysis and forecasting; network resilience evaluation and optimization; resource allocation and scheduling; and customer experience personalization.
15. In some embodiments, the method further comprises implementing knowledge transfer mechanisms including: teacher-student model training where complex models guide the training of simplified models; parameter compression to reduce model size while preserving critical functionality; domain-specific optimization to maximize performance on targeted functions; federated learning to enable privacy-preserving distributed model improvement; and catastrophic forgetting prevention to maintain critical capabilities during updates.
16. A system for distributed intelligence in utility network management, comprising: a plurality of artificial intelligence processing units deployed at multiple tiers of utility network topology, each unit comprising: a processor configured to execute artificial intelligence models; memory storing artificial intelligence models optimized for the unit's operational domain; communication interfaces for secure information exchange with other units; sensors for collecting operational data relevant to the unit's domain; a central management system providing: model distribution and versioning; security policy management; performance monitoring and optimization; system-wide configuration control; a secure communication network connecting the processing units and central management system, supporting: encrypted data exchange; bandwidth-efficient information sharing; resilient operation during network disruptions; and prioritized message handling based on operational significance.

### Certain Definitions and Additional Considerations

Unless otherwise defined, all technical terms used herein have the same meaning as commonly understood by one of ordinary skill in the art to which this disclosure belongs.

As used in this specification and the appended claims, the terms “machine learning,” “machine learning techniques,” “machine learning algorithm,” “machine learning operation,” and “machine learning model” generally refer to any system or analytical or statistical procedure that may progressively improve computer performance of a task.

As used in this specification and the appended claims, the singular forms “a,” “an,” and “the” include plural references unless the context clearly dictates otherwise.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out.

The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

As used herein, “or” is intended to mean an “inclusive or” or what is also known as a “logical OR,” wherein when used as a logic statement, the expression “A or B” is true if either A or B is true, or if both A and B are true, and when used as a list of elements, the expression “A, B or C” is intended to include all combinations of the elements recited in the expression, for example, any of the elements selected from the group consisting of A, B, C, (A, B), (A, C), (B, C), and (A, B, C); and so on if additional elements are listed. As such, any reference to “or” herein is intended to encompass “and/or” unless otherwise stated.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it may be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

It will be understood that, although the terms “first,” “second,” “third,” etc. may be used herein to describe various elements, these elements should not be limited by these terms. These terms are only used to distinguish one element from another. For example, a first element may be termed a second element, and, similarly, a second element may be termed a first element, without departing from the scope of the present disclosure.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein, like characters refer to like elements.

While preferred embodiments of the present disclosure have been shown and disclosed herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure disclosed herein may be employed in practicing the disclosure. It is intended that the following claims define the scope of the disclosure and that methods and structures within the scope of these claims and their equivalents be covered thereby.

It should be noted that various illustrative or suggested ranges set forth herein are specific to their example embodiments and are not intended to limit the scope or range of disclosed technologies, but, again, merely provide example ranges for frequency, amplitudes, etc. associated with their respective embodiments or use cases. Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

It should be understood that, unless a term is expressly defined in this disclosure, there is no intent to limit the meaning of that term, either expressly or by implication, beyond its plain or ordinary meaning, and such term should not be interpreted to be limited in scope based at least in part on any statement made in any section of this disclosure (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are disclosed herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as disclosed herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, hardware modules may encompass a tangible entity, be that an entity that is physically constructed, permanently configured (e.g., hardwired), or temporarily configured (e.g., programmed) to operate in a certain manner or to perform certain operations disclosed herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information). Elements that are described as being coupled and or connected may refer to two or more elements that may be (e.g., direct physical contact) or may not be (e.g., electrically connected, communicatively coupled, etc.) in direct contact with each other, but yet still cooperate or interact with each other.

The various operations of example methods disclosed herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines disclosed herein may be at least partially processor-implemented. For example, at least some of the operations of a method may be performed by one or more processors or processor-implemented hardware modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain operations may be distributed among the one or more processors, not only residing within a single machine, but deployed across a number of machines. In some example embodiments, the one or more processors or processor-implemented modules may be located in a single geographic location (e.g., within an office environment, or a server farm). In other example embodiments, the one or more processors or processor-implemented modules may be distributed across a number of geographic locations.

1. A distributed utility intelligence architecture, comprising:
at least four hierarchical tiers of one or more artificial intelligence (AI) components configured to manage a utility network, wherein the at least four hierarchical tiers of one or more AI components comprise a first tier of one or more first AI components, a second tier of one or more second AI components, a third tier of one or more third AI components, and a fourth tier of one or more fourth AI components; wherein:
(i) the first tier is configured to direct activity of at least the second tier, the third tier, and the fourth tier, wherein the first tier is configured to monitor electrical data of the utility network;
(ii) second tier is configured to direct activity of at least the third tier and fourth tier, wherein the second tier is configured to monitor electrical data of a transformer within the utility network;
(iii) the third tier is configured to direct activity of at least the fourth tier, wherein the third tier is configured to monitor electrical data of a service point corresponding to the transformer; and
(iv) the fourth tier is configured to monitor electrical data of an appliance at the service point.

2. The distributed utility intelligence architecture of claim 1, wherein one or more of the one or more first AI components, the one or more second AI components, the one or more third AI components, or the one or more fourth AI components comprise a processing unit and a sensory interface unit.

3. The distributed utility intelligence architecture of claim 2, wherein:
(i) the processing unit comprises an AI model that is configured to perform a utility operation function;
(ii) the sensory interface unit is configured to provide utility sensor data to the processing unit; and
(iii) the processing unit is configured to process the utility sensor data with the AI model to perform the utility operation function.

4. The distributed utility intelligence architecture of claim 3, wherein the AI model comprises a neural network model, and wherein the distributed utility intelligence architecture is configured to perform a parameter compression technique to reduce a size of the neural network model.

5. The distributed utility intelligence architecture of claim 2, wherein the sensory interface unit is configured to use one or more of: an electrical parameter, a network parameter, an environmental parameter, or a state parameter.

6. The distributed utility intelligence architecture of claim 2, wherein the sensory interface unit comprises a sensor interface layer, a signal processing layer, an event detection layer, a context enrichment layer, and a communication layer, wherein:
(i) the sensor interface layer comprises a hardware-specific driver for data acquisition;
(ii) the signal processing layer comprises a digital signal processing algorithm configured to perform data transformation; and
(iii) the event detection layer is configured to perform pattern matching or threshold monitoring to detect network events.

7. The distributed utility intelligence architecture of claim 1, wherein the distributed utility intelligence architecture is configured to refine, using federated learning, one or more of: the one or more first AI components, the one or more second AI components, the one or more third AI components, or the one or more fourth AI components.

8. The distributed utility intelligence architecture of claim 1, wherein the distributed utility intelligence architecture is configured to perform one or both of: elastic weight consolidation or knowledge distillation regularization.

9. The distributed utility intelligence architecture of claim 1, wherein the at least four hierarchical tiers are configured such that information flows one or both of:
(i) upward from the fourth tier to the third tier, from the third tier to the second tier, or from the second tier to the first tier, or
(ii) downward from the first tier to the second tier, from the second tier to the third tier, or from the third tier to the fourth tier.

10. The distributed utility intelligence architecture of claim 1, wherein the at least four hierarchical tiers are configured such that information flows one or both of:
(i) horizontally between one AI component and another AI component in a same tier, or
(ii) across tiers that are not directly connected.

11. The distributed utility intelligence architecture of claim 1, wherein the distributed utility intelligence architecture comprises one or more of: a grid stability model, an asset health model, a consumption pattern model, a network resilience model, a resource optimization model, or a customer experience model.

12. The distributed utility intelligence architecture of claim 1, further comprising a generative AI agent configured to autonomously generate a software tool to address an operational gap identified during continuous grid monitoring.

13. The distributed utility intelligence architecture of claim 2, wherein a processing unit of the one or more first AI components is included in the first tier, and wherein the processing unit of the one or more first AI components comprises a neural network with at least 1,000,000 parameters.

14. The distributed utility intelligence architecture of claim 1, wherein the one or more first AI components in the first tier are deployed on an online grid management and monitoring platform.

15. The distributed utility intelligence architecture of claim 1, wherein the one or more first AI components in the first tier are configured to receive telemetry data from the one or more second AI components in the second tier, and wherein the telemetry data from the one or more second AI components in the second tier comprises data corresponding to one or more of: transformer-level power flow, outage reports, or weather data.

16. The distributed utility intelligence architecture of claim 15, wherein the one or more first AI components in the first tier are configured to:
(i) perform system-wide load pattern analysis of the utility network based on the telemetry data from the one or more second AI components in the second tier; and
(ii) if the system-wide load pattern analysis forecasts an impending demand peak, instruct the one or more second AI components in the second tier to implement a directive to handle the impending demand peak, wherein the directive is a load-shedding plan or demand-response initiative.

17. The distributed utility intelligence architecture of claim 15, wherein the one or more first AI components in the first tier are configured to correlate the data corresponding to transformer-level power flow with one or both of: historical consumption data or the weather data.

18. The distributed utility intelligence architecture of claim 1, wherein the one or more first AI components in the first tier are configured to predict demand spikes on the utility network and adjust system-wide distribution strategies on the network in response to the predicted demand spikes.

19. The distributed utility intelligence architecture of claim 1, wherein the one or more first AI components in the first tier are configured to perform demand forecasting for the utility network.

20. The distributed utility intelligence architecture of claim 1, wherein the one or more first AI components in the first tier are configured to predict a load distribution on the utility network between about 24 hours and about 72 hours in advance of electricity use.

21. The distributed utility intelligence architecture of claim 1, wherein the one or more first AI components in the first tier are configured to:
(i) detect a distribution-level anomaly affecting two or more circuits of the utility network;
(ii) in response to detecting the distribution-level anomaly, one or more of: alert a utility operator, dispatch an automated alert, isolate an affected segment, or initiate a further diagnostic process.

22. The distributed utility intelligence architecture of claim 21, wherein the distribution-level anomaly comprises simultaneous voltage fluctuations across the two or more circuits that are outside of typical usage patterns of the utility network.

23. The distributed utility intelligence architecture of claim 1, wherein the one or more first AI components in the first tier are configured to perform long-range load forecasting for resource planning.

24. The distributed utility intelligence architecture of claim 2, wherein a processing unit of the one or more second AI components is included in the second tier, and wherein the processing unit of the one or more second AI components comprises a neural network with between 1,000 parameters and 100,000 parameters.

25. The distributed utility intelligence architecture of claim 1, wherein the one or more second AI components in the second tier are deployed on one or more distribution transformer smart hubs corresponding to the transformer of the utility network.

26. The distributed utility intelligence architecture of claim 1, wherein the one or more second AI components in the second tier are configured to:
(i) receive telemetry data from the one or more third AI components in the third tier, wherein the telemetry data from the one or more third AI components in the third tier comprises data of transformer temperature and data of load distribution; and
(ii) perform local electrical characteristic analysis using the data of load distribution and the data of transformer temperature to predict potential transformer overheating of the transformer of the utility network.

27. The distributed utility intelligence architecture of claim 1, wherein the one or more second AI components in the second tier are configured to:
(i) detect a temperature anomaly or a transformer overloading; and
(ii) in response to detecting the temperature anomaly or the transformer overloading, implement a control directive on the transformer of the utility network, wherein the control directive instructs the distributed utility intelligence architecture to one or more of: dynamically adjust tap changer settings, redistribute local load, or adjust a local circuit parameter.

28. The distributed utility intelligence architecture of claim 1, wherein the one or more second AI components in the second tier are configured to:
(i) detect a transformer-level anomaly of the transformer of the utility network, wherein the transformer-level anomaly comprises a rapid increase in transformer vibration or a temperature spike without a corresponding load change of the transformer of the utility network; and
(ii) if the transformer-level anomaly is detected, one or more of: generate a maintenance work order, initiate local load redistribution to mitigate risk, or communicate with the one or more first AI components in the first tier.

29. The distributed utility intelligence architecture of claim 1, wherein the one or more second AI components in the second tier are configured to perform medium-range equipment health prediction for maintenance planning on the transformer of the utility network.

30. The distributed utility intelligence architecture of claim 2, wherein a processing unit of the one or more third AI components is included in the third tier, and wherein the processing unit of the one or more third AI components comprises a neural network with between 100 parameters and 999 parameters.

31. The distributed utility intelligence architecture of claim 1, wherein the one or more third AI components in the third tier are deployed on one or more smart meters at the service point, wherein the one or more third AI components in the third tier are configured to:
(i) collect customer usage data at the service point at regular intervals, wherein the customer usage data comprises one or more of: kilowatt-hour (kWh) consumption, a voltage dip or spike, an outage, or a demand profile, wherein the regular intervals are 5-minute increments, 15-minute increments, or 30-minute increments;
(ii) use the customer usage data to detect abnormal electricity usage at the service point as compared to historical usage patterns; and
(iii) if the abnormal electricity usage at the service point is detected, one or more of: notify the one or more second AI components in the second tier, flag data from the service point for increased monitoring, or log event details for utility records.

32. The distributed utility intelligence architecture of claim 1, wherein the one or more third AI components in the third tier are configured to perform short-range consumption prediction for load balancing.

33. The distributed utility intelligence architecture of claim 2, wherein a processing unit of the one or more fourth AI components is included in the fourth tier, and wherein the processing unit of the one or more fourth AI components comprises an inference model with fewer than 100 parameters.

34. The distributed utility intelligence architecture of claim 1, wherein the one or more fourth AI components in the fourth tier are deployed on one or more in-home or business wireless routers, wherein the one or more fourth AI components in the fourth tier are configured to:
(i) detect degraded telemetry of the appliance; and
(ii) cause modification of operation of the appliance based on the degraded telemetry of the appliance.

35. The distributed utility intelligence architecture of claim 1, wherein the one or more fourth AI components in the fourth tier are configured to:
(i) detect a usage anomaly of the appliance; and
(ii) if the usage anomaly of the appliance is detected, one or more of: issue a user-level alert, issue an automated configuration adjustment to stabilize connectivity of the appliance, or provide personalized guidance to the customer through a customer engagement platform.

36. The distributed utility intelligence architecture of claim 1, wherein the one or more fourth AI components in the fourth tier are configured to perform immediate range connectivity prediction for quality of service.

37. The distributed utility intelligence architecture of claim 1, further comprising a fifth tier of one or more fifth AI components, wherein the fifth tier is configured to monitor electrical data of one or more of: an electrical substation, a power plant, or a transmission line.

38. A method for managing a utility network, the method comprising:
a) monitoring electrical data of a utility network using one or more first AI components;
b) monitoring electrical data of a transformer within the utility network using one or more second AI components;
c) monitoring electrical data of a service point corresponding to the transformer using one or more third AI components; and
d) monitoring electrical data of an appliance located at the service point using one or more fourth AI components;
wherein the one or more first AI components are included in a first hierarchical tier that directs activity of the one or more second AI components, the one or more third AI components, and the one or more fourth AI components,
wherein the one or more second AI components are included in a second hierarchical tier that directs activity of the one or more third AI components and the one or more fourth AI components,
wherein the one or more third AI components are included in a third hierarchical tier that directs activity of the one or more fourth AI components, and
wherein the one or more fourth AI components are included in a fourth hierarchical tier.
